(19) United States
(12) Patent Application Publication
(10) Pub. No.: US 2017/0076144 A1
(43) Pub. Date: Mar. 16, 2017

(54) VIDEO DISPLAY SYSTEM, IMAGE DISPLAY CONTROL METHOD, AND RECORDING MEDIUM STORING IMAGE DISPLAY CONTROL PROGRAM

(71) Applicants: Ryo IWASAKI, Tokyo (JP); Kei OYAMADA, Kanagawa (JP); Aritaka HAGIWARA, Kanagawa (JP); Hidekuni ANNAKA, Saitama (JP); Tomoyuki TSUKUDA, Kanagawa (JP); Eijiro INOUE, Kanagawa (JP); Yoko MIZUNASHI, Kanagawa (JP)

(72) Inventors: Ryo IWASAKI, Tokyo (JP); Kei OYAMADA, Kanagawa (JP); Aritaka HAGIWARA, Kanagawa (JP); Hidekuni ANNAKA, Saitama (JP); Tomoyuki TSUKUDA, Kanagawa (JP); Eijiro INOUE, Kanagawa (JP); Yoko MIZUNASHI, Kanagawa (JP)

(73) Assignee: Ricoh Company, Ltd., Tokyo (JP)

(21) Appl. No.: 15/253,930

(22) Filed: Sep. 1, 2016

(30) Foreign Application Priority Data
Sep. 11, 2015 (JP) 2015-179860
Aug. 1, 2016 (JP) 2016-151509

(51) Int. Cl. G06K 9/00; G06T 7/20; H04N 9/31

(52) U.S. Cl. CPC G06K 9/00288; G06K 9/00758; H04N 9/31; G06K 9/00255; G06T 7/20

(57) ABSTRACT

A video display system, an image display control method, and a recording medium storing an image display control program. Each of the video display system, the image display control method, and the recording medium includes obtaining a facial image of a user who uses at least one of a plurality of information processing devices, comparing the obtained facial image with a plurality of facial images each of which is associated with each of the information processing devices, the facial images being stored in advance as association information, selecting one of the information processing devices associated with the obtained facial image, based on a result of comparison between the obtained facial image and the plurality of facial images, obtaining a video signal from the selected information processing device, and displaying a video based on the obtained video signal.

### CROSS-REFERENCE TO RELATED APPLICATIONS

This patent application is based on and claims priority pursuant to 35 U.S.C. §119(a) to Japanese Patent Application Nos. 2015-179860 and 2016-151509, filed on Sep. 11, 2015, and Aug. 1, 2016, respectively, in the Japan Patent Office, the entire disclosures of which is are hereby incorporated by reference herein.

### BACKGROUND

Technical Field

Embodiments of the present invention relate to a video display system, an image display control method, and a recording medium storing an image display control program.

Background Art

In recent years, video display systems in which a video display device such as a projector and a display is connected to a plurality of information processing devices such as tablet personal computers (PCs), personal computers (PCs), and smartphones through the network are known in the art.

In such a video display system, a host of the video display system selects one of a plurality of information processing devices as an information processing device from which moving images are to be projected. Then, the selected information processing device sends video signals to the video display device, and the video display device displays the moving images based on the received video signals.

### SUMMARY

Embodiments of the present invention described herein provide a video display system, an image display control method, and a recording medium storing an image display control program. Each of the video display system, the image display control method, and the recording medium storing the image display control program includes obtaining a facial image of a user who uses at least one of a plurality of information processing devices, comparing the obtained facial image with a plurality of facial images each of which is associated with each of the plurality of information processing devices, the facial images being stored in advance as association information, selecting one of the plurality of information processing devices associated with the obtained facial image, based on a result of comparison between the obtained facial image and the plurality of facial images, obtaining a video signal from the selected information processing device, and displaying a video based on the obtained video signal.

### BRIEF DESCRIPTION OF THE DRAWINGS

A more complete appreciation of exemplary embodiments and the many attendant advantages thereof will be readily obtained as the same becomes better understood by reference to the following detailed description when considered in connection with the accompanying drawings.

FIG. 1 illustrates a configuration of a video display system according to an embodiment of the present invention.

FIG. 2 is a schematic block diagram illustrating a hardware configuration of a projector according to an embodiment of the present invention.

FIG. 3 is a schematic block diagram illustrating a functional configuration of a projector according to an embodiment of the present invention.

FIG. 4 is a diagram illustrating a user list that a projector manages with a user manager, according to an embodiment of the present invention.

FIG. 5 is a diagram illustrating a terminal list that a projector manages with a terminal manager, according to an embodiment of the present invention.

FIG. 6 is a schematic block diagram illustrating a functional configuration of a client communication terminal, according to an embodiment of the present invention.

FIG. 7 is a sequence diagram of processes in which a user of a video display system connects a client communication terminal of the user to a projector, according to an embodiment of the present invention.

FIG. 8 is a diagram illustrating a facial image capturing screen displayed on a client communication terminal, according to an embodiment of the present invention.

FIG. 9 is a diagram illustrating processes in which a projector projects an image captured by a client communication terminal, according to an embodiment of the present invention.

FIG. 10 is a diagram illustrating a to-be-projected subject selection screen displayed on a client communication terminal, according to an embodiment of the present invention.

FIG. 11 is a diagram illustrating a terminal list that a projector manages with a terminal manager, according to an embodiment of the present invention.

FIG. 12 is a sequence diagram of processes in which a user of a video display system registers a client communication terminal of the user to a projector, according to an embodiment of the present invention.

FIG. 13 is a sequence diagram of processes in which a user of a video display system connects a client communication terminal of the user to a projector, according to an embodiment of the present invention.

FIG. 14 is a schematic block diagram illustrating a functional configuration of a projector according to an embodiment of the present invention.

FIG. 15 is a diagram illustrating an ARP table that a projector manages with an ARP table manager, according to an embodiment of the present invention.

FIG. 16 is a diagram illustrating a terminal list that a projector manages with a terminal manager, according to an embodiment of the present invention.

FIG. 17 is a sequence diagram of processes in which a user of a video display system registers a client communication terminal of the user to a projector, according to an embodiment of the present invention.

FIG. 18 is a sequence diagram illustrating processes of updating an ARP table that an ARP table manager of a projector manages, according to an embodiment of the present invention.

FIG. 19 is a diagram illustrating processes in which a projector projects an image captured by a client communication terminal, according to an embodiment of the present invention.

FIG. 20 is a diagram illustrating a terminal list that a projector manages with a terminal manager, according to an embodiment of the present invention.

FIG. 21 is a sequence diagram of processes in which a user of a video display system registers a client communication terminal of the user to a projector, according to an embodiment of the present invention.

FIG. 22 is a diagram illustrating a terminal list screen displayed on a client communication terminal, according to an embodiment of the present invention.

FIG. 23 is a diagram illustrating processes in which a projector projects an image captured by a client communication terminal, according to an embodiment of the present invention.

FIG. 24 is a diagram illustrating a terminal list that a projector manages with a terminal manager, according to an embodiment of the present invention.

FIG. 25 is a diagram illustrating captured images that are projected on a projection plane by a projector, according to an embodiment of the present invention.

FIG. 26 is a diagram illustrating an impossible selection notification screen displayed on a client communication terminal, according to an embodiment of the present invention.

FIG. 27 is a diagram illustrating a display position selection screen displayed on a client communication terminal, according to an embodiment of the present invention.

FIG. 28 illustrates a configuration of a video display system according to an embodiment of the present invention.

FIG. 29 is a schematic block diagram illustrating a functional configuration of a projector according to an embodiment of the present invention.

FIG. 30 is a diagram illustrating processes in which a projector projects an image captured by a client communication terminal, according to an embodiment of the present invention.

FIG. 31 is a diagram illustrating moving images captured by a camera, according to an embodiment of the present invention.

FIG. 32 is a diagram illustrating processes in which a projector projects an image captured by a client communication terminal, according to an embodiment of the present invention.

FIG. 33 is a diagram illustrating moving images captured by a camera, according to an embodiment of the present invention.

FIG. 34 is a diagram illustrating a user list that a projector manages with a user manager, according to an embodiment of the present invention.

FIG. 35 is a diagram illustrating processes of registering a gesture to be detected, using a gesture detector, according to an embodiment of the present invention.

FIG. 36 is a diagram illustrating a gesture list managed by a gesture detector, according to an embodiment of the present invention.

FIG. 37 is a diagram illustrating processes in which a projector projects an image captured by a client communication terminal, according to an embodiment of the present invention.

FIG. 38 is a diagram illustrating processes of registering a gesture to be detected, using a gesture detector, according to an embodiment of the present invention.

FIG. 39 is a diagram illustrating a gesture list managed by a gesture detector, according to an embodiment of the present invention.

FIG. 40A and FIG. 40B are a diagram illustrating processes in which a projector projects an image captured by a client communication terminal, according to an embodiment of the present invention.

FIG. 41A and FIG. 41B are a sequence diagram illustrating processes in which a user of a video display system terminates the projection of an image captured by a client communication terminal of his/her own, according to an embodiment of the present invention.

FIG. 42 is a diagram illustrating control permission setting information associated with a client communication terminal, according to an embodiment of the present invention.

The accompanying drawings are intended to depict exemplary embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more central processing units (CPUs), digital signal processors (DSPs), application-specific-integrated-circuits (ASICs), field programmable gate arrays (FPGAs), computers or the like. These terms in general may be collectively referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

### First Embodiment

Embodiments of the present invention are described below in detail with reference to the drawings. In the present embodiment, a video display system is described in which a video display device such as a projector and a display is connected to a plurality of information processing devices such as tablet personal computers (PCs), personal computers (PCs), and smartphones through the network.

In the present embodiment, the description is given under the following assumptions. In a conference or lecture, the host of a video display system selects one of a plurality of information processing devices as an information processing device from which moving images are to be projected. Then, the selected information processing device sends video signals to a video display device, and the video display device displays the moving images based on the received video signals.

In such a configuration, the host (manager) of the video display system has to use the information processing device of his/her own to select an information processing device from which moving images are to be projected, from a list of information processing devices of participants.

In other words, in conventional video display systems, when an information processing device from which moving images are to be projected is to be selected, the host has to seek a relevant information processing device from a list of a plurality of information processing devices.

In order to deal with such a situation, firstly, the video display system according to the present embodiment associates the facial images of participants with the information processing devices that the participants operate, and produces a list in advance.

Then, in the video display system according to the present embodiment, the host uses the information processing device of his/her own to capture the facial image of the participant who operates the information processing device from which moving images are to be projected. Accordingly, the information processing device that is associated with the captured facial image is selected from the above-produced list. Then, the video display device in the video display system according to the present embodiment displays moving images based on the video signals sent from the information processing device as selected above.

Due to this configuration of the video display system according to the present embodiment, when the information processing device from which moving images are to be projected is to be selected, the only thing that the host has to do is to capture the facial image of the participant who operates the target information processing device. In other words, the host no longer has to seek a target information processing device on his/her own from the list of a plurality of information processing devices. Accordingly, the video display system according to the present embodiment can improve customer convenience mainly on the host side.

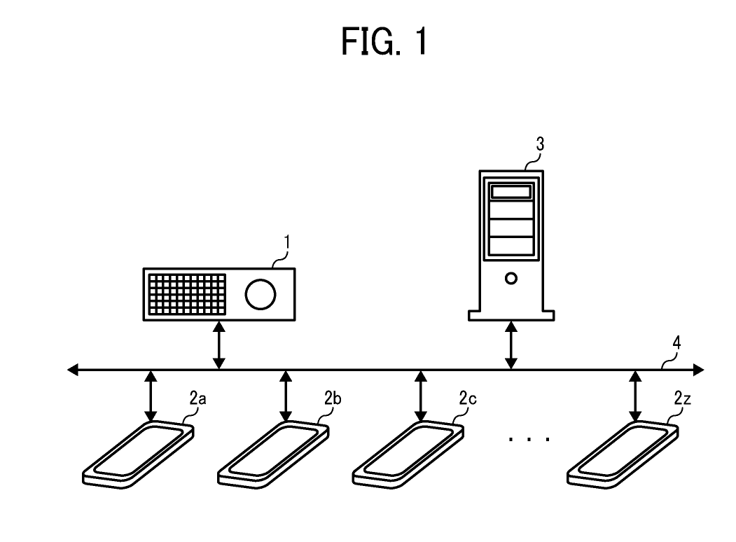

FIG. 1 illustrates a configuration of a video display system according to the present embodiment.

As illustrated in FIG. 1, in the video display system according to the present embodiment, a projector 1, client communication terminals 2a to 2z, and a dynamic host configuration protocol (DHCP) server 3 are connected to each other through the network 4.

In the following description, it is assumed the client communication terminal 2a is operated by a host and the client communication terminals 2b to 2z are operated by participants. When it is not necessary to distinguish the client communication terminals 2a to 2z from each other in the following description, the client communication terminals 2a to 2z are collectively be referred to as the client communication terminals 2.

The number of the client communication terminals 2 that are connected to the network 4 is not limited. Any greater number of client communication terminals may be connected to the network 4 in large-scale system.

The projector 1 modulates the laser-beam bundles emitted from a light source according to the input video signals to form an optical image. Then, the projector 1 magnifies the formed projection image and projects it onto a projection plane such as a wall or a screen. In the present embodiment, moving images are projected according to the video signals sent from the client communication terminals 2. In other words, in the present embodiment, the projector 1 serves as a video display unit.

The client communication terminal 2 is an information processing terminal operated by a host or a participant, and is implemented by information processing devices such as a personal computer (PC), a personal digital assistant (PDA), a smartphone, and a tablet PC. In the present embodiment, when the client communication terminal 2 is selected as a device from which moving images are to be projected, the client communication terminal 2 captures the being-displayed moving images, and sends the video signals of the captured images to the projector 1.

The network 4 is a limited network such as the local area network (LAN) at an office. The network 4 is implemented, for example, by a network using the Ethernet (registered trademark), a universal serial bus (USB), Bluetooth (registered trademark), wireless fidelity (Wi-Fi) (registered trademark), FeliCa (registered trademark), peripheral component interconnect express (PCIe), a video graphics array (VGA), a digital visual interface (DVI), and an interface manufactured under the institute of electrical and electronics engineers (IEEE) standard.

The DHCP server 3 automatically issues information such as an Internet protocol (IP) address to a computer that is temporarily connected to the network such as the Internet. In other words, in the present embodiment, the DHCP server 3 serves as a location identification information manager.

In the video display system as configured above, the client communication terminals 2b to 2z and the facial images of the participants who operate these communication terminals 2b to 2z are associated with each other and a list is produced in advance. Then, the client communication terminal 2 that is associated with the facial image of a participant captured by the client communication terminal 2a of the host is automatically selected from the list.

Due to this configuration of the video display system according to the present embodiment, when the client communication terminal 2 from which a captured image is to be projected is to be selected, the only thing that the host has to do is to capture the facial image of the participant who operates the target client communication terminal 2. In other words, the host no longer has to seek a target client communication terminal 2 on his/her own from the list of a plurality of client communication terminals 2. Accordingly, the video display system according to the present embodiment can improve customer convenience.

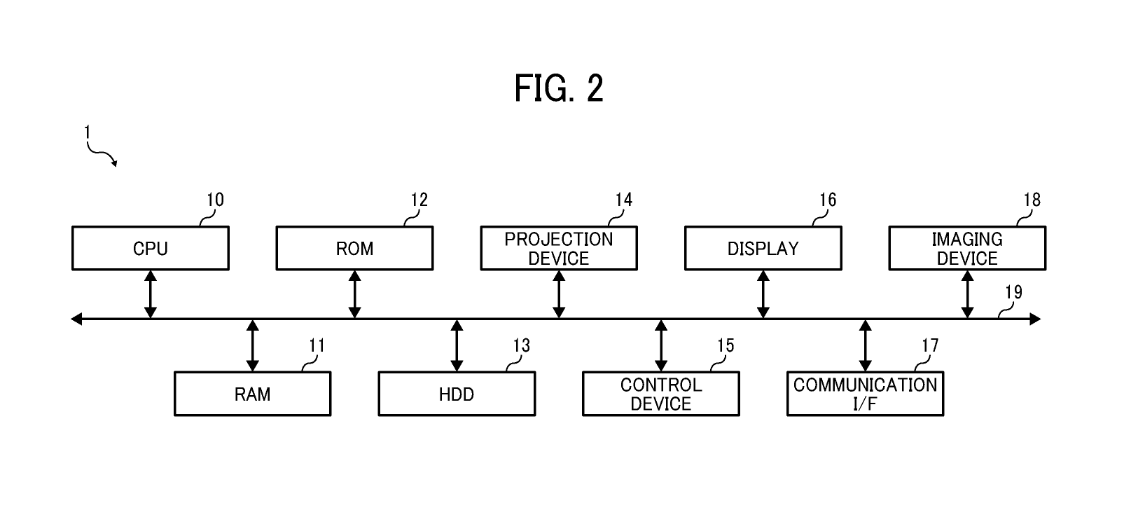

FIG. 2 is a schematic block diagram illustrating a hardware configuration of the projector 1 according to the present embodiment. Although an example hardware configuration of the projector 1 is illustrated in FIG. 2, a hardware configuration of the client communication terminal 2 is similar to the configuration of the projector 1.

As illustrated in FIG. 2, in the projector 1 according to the present embodiment, a central processing unit (CPU) 10, a random access memory (RAM) 11, a read only memory (ROM) 12, a hard disk drive (HDD) 13, a projection device 14, a control device 15, a display 16, a communication interface (I/F) 17, and an imaging device 18 are coupled to each other through a communication interface 19.

The CPU 10 serves as a computation unit, and controls the entire operation of the projector 1. The RAM 11 is a volatile storage medium capable of reading and writing data at high speed, and is used as a working area when the CPU 10 processes data. The ROM 12 is a read-only nonvolatile storage medium in which programs such as firmware are stored.

The HDD 13 is a data readable/writable nonvolatile memory in which various kinds of data such as image data, an operating system (OS), various kinds of control programs, or various kinds of programs such as an application program are stored.

The projection device 14 is hardware that implements specific functions in the projector 1. More specifically, the projection device 14 modulates the laser-beam bundles emitted from a light source to form an optical image, and magnifies the formed projection image and projects it onto a projection plane such as a wall or a screen. Note that each of the client communication terminals 2 does not have to be provided with the projection device 14 as the client communication terminals 2 are information processing terminals that are operated by a host or a participant.

The control device 15 is a user interface used to input data to the projector 1, and is implemented by an input device such as a keyboard, a mouse, an input key, and a touch panel.

The display 16 is a user interface that allows a user to visually monitor the status of the projector 1, and is implemented by a display device such as a liquid crystal display (LCD) and an output device such as a light-emitting diode (LED).

The imaging device 18 is a solid-state image sensing device such as a charge-coupled device (CCD) and a complementary metal oxide semiconductor (CMOS), and captures images around the projector 1 and converts the captured images into electrical signals.

The network interface 19 is an interface used to enable the projector 1 to communicate with other devices through the network, and the Ethernet (registered trademark), a universal serial bus (USB), Bluetooth (registered trademark), Wi-Fi (registered trademark), FeliCa (registered trademark), PCIe, an interface manufactured under the IEEE standard, or the like are used as the network interface 19.

In such a hardware configuration, programs stored on a storage medium such as the ROM 12 and the HDD 13 are read by the RAM 11, and the CPU 10 performs computation according to these programs loaded onto the RAM 11. This series of processes configures a software controller.

The software controller as configured above and hardware are combined to configure a functional block that implements the functions of the projector 1 and the client communication terminals 2 according to the present embodiment.

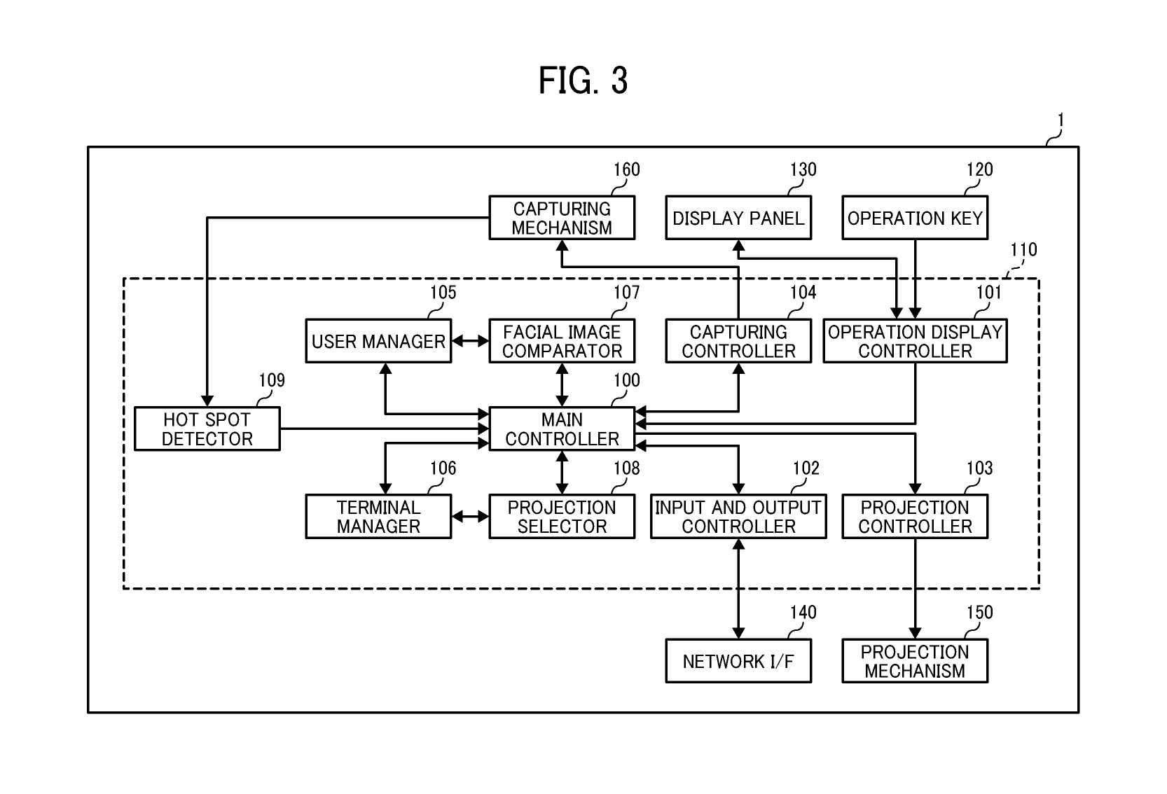

Next, a functional configuration of the projector 1 according to the present embodiment is described with reference to FIG. 3. FIG. 3 is a schematic block diagram illustrating a functional configuration of the projector 1 according to the present embodiment.

As illustrated in FIG. 3, the projector 1 according to the present embodiment includes a controller 110, an operation key 120, a display panel 130, a network interface (I/F) 140, a projection mechanism 150, and a capturing mechanism 160. Moreover, the controller 110 includes a main controller 100, an operation display controller 101, an input and output controller 102, and a projection controller 103, a capturing controller 104, a user manager 105, a terminal manager 106, a facial image comparator 107, a projection selector 108, and a hot spot detector 109.

The operation key 120 is an input interface used by a user to directly operate the projector 1 and to input data to the projector 1. The operation key 120 is implemented by the control device 15 illustrated in FIG. 2.

The display panel 130 is an output interface on which the status of the projector 1 is visually displayed, and also is an input interface such as a touch panel used by a user to directly operate the projector 1 or to input data to the projector 1. Moreover, the display panel 130 may display an image to accept a user operation. The display panel 130 is implemented by the control device 15 and the display 16 illustrated in FIG. 2.

The network interface 140 is an interface used to enable the projector 1 to communicate with other devices such as the client communication terminals 2 through the network, and the Ethernet (registered trademark), a universal serial bus (USB), Bluetooth (registered trademark), Wi-Fi (registered trademark), FeliCa (registered trademark), PCIe, an interface manufactured under the IEEE standard, or the like are used as the network interface 140. The network interface 140 is implemented by the communication interface 17 illustrated in FIG. 2.

The projection mechanism 150 is an output interface that modulates the laser-beam bundles emitted from a light source to form an optical image, magnifies the formed projection image, and projects the magnified projection image onto a projection plane such as a wall or a screen. The projection mechanism 150 is implemented by the projection device 14 illustrated in FIG. 2.

The capturing mechanism 160 is a solid-state image sensing device such as a CCD and a CMOS, and also is an input interface that captures images around the projector 1 and converts the captured images into electrical signals. The capturing mechanism 160 is implemented by the imaging device 18 illustrated in FIG. 2.

The controller 110 is configured by a combination of software and hardware. More specifically, a program that is stored in a storage medium such as the ROM 12 and the HDD 13 is loaded into the RAM 11 by the CPU 10, and the controller 110 is configured by a combination of hardware such as an integrated circuit and a software controller configured by the computation performed by the CPU 10 according to the program.

The main controller 100 controls each element of the controller 110, and gives a command to each element of the controller 110. The main controller 100 controls the input and output controller 102, and accesses other devices through the network interface 140.

The operation display controller 101 controls the display panel 130 to display an image under the control of the main controller 100, or inputs data, a signal, or a command, which are input through the operation key 120 or the display panel 130, to the main controller 100. Then, the main controller 100 gives a command to each element of the controller 110 according to the data, signal, or the command input by the operation display controller 101.

The input and output controller 102 sends data, a signal, or a command to other devices through the network interface 140 under the control of the main controller 100, or inputs the data, signal, or the command, which are input through the network interface 140, to the main controller 100. Then, the main controller 100 gives a command to each element of the controller 110 according to the data, signal, or the command input by the input and output controller 102.

The projection controller 103 serves as a video display controller that controls or drives the projection mechanism 150 under the control of the main controller 100 to control the moving images that are projected by the projector 1. The capturing controller 104 controls or drives the capturing mechanism 160 under the control of the main controller 100.

The user manager 105 manages a user list in which the facial images of the users of the video display system are associated with the user ID of the users.

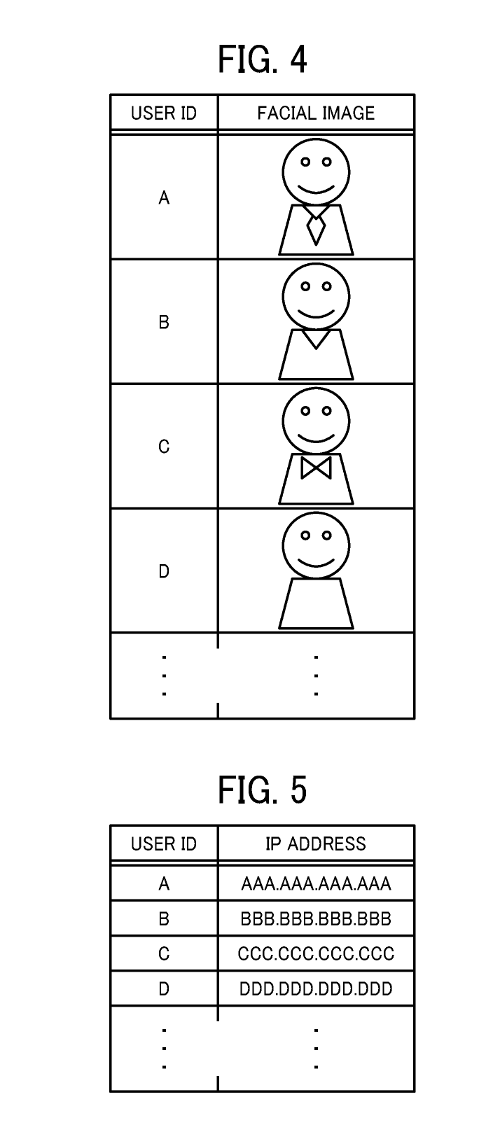

FIG. 4 is a diagram illustrating a user list that the user manager 105 of the projector 1 manages, according to the present embodiment.

The terminal manager 106 manages a terminal list in which the IP addresses of the client communication terminals 2 are associated with the user ID of the users who operate these client communication terminals 2.

FIG. 5 is a diagram illustrating a terminal list that the terminal manager 106 of the projector 1 manages, according to the present embodiment. In other words, such a user list and a terminal list are used as association information in the present embodiment.

The facial image comparator 107 compares the facial image of a participant who operates the client communication terminal 2 from which a captured image is to be projected, which is sent from the client communication terminal 2a that the host operates, with the facial images that are registered to a user list managed by the user manager 105. Then, based on the results of the comparison, the facial image comparator 107 selects the user ID that is associated with the best-matching facial image from the user list.

The projection selector 108 selects, from the terminal list managed by the terminal manager 106, the client communication terminal 2 from which a captured image is to be projected, based on the user ID selected by the facial image comparator 107.

The hot spot detector 109 detects a spot being pointed by a user of the video display system on the screen where moving images are projected by the projector 1.

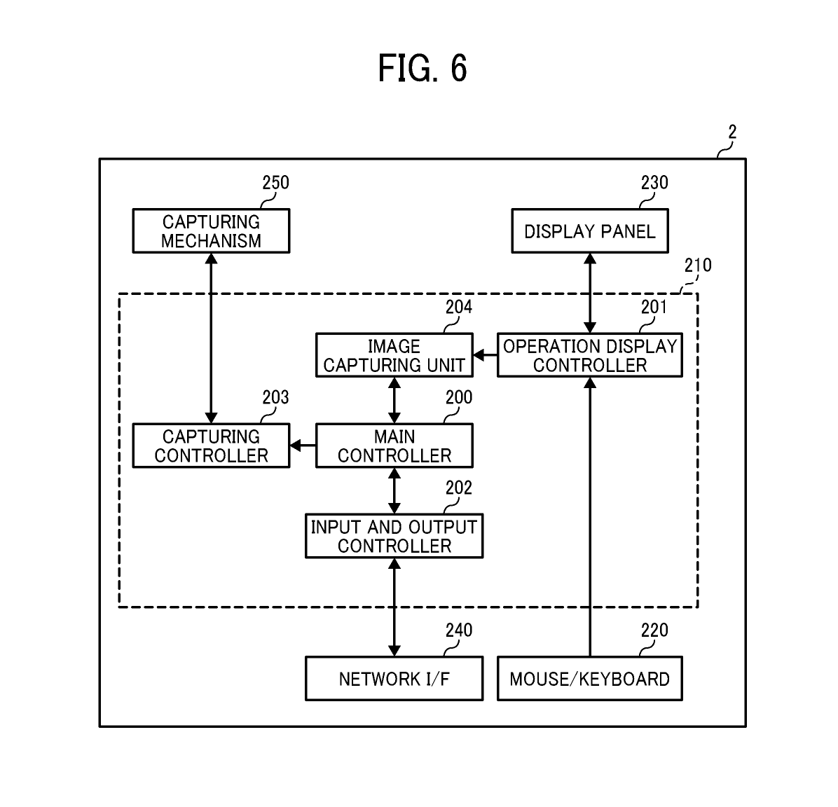

Next, a functional configuration of the client communication terminal 2 according to the present embodiment is described with reference to FIG. 6. FIG. 6 is a schematic block diagram illustrating a functional configuration of the client communication terminal 2, according to the present embodiment.

As illustrated in FIG. 6, the client communication terminal 2 according to the present embodiment includes a controller 210, a mouse/keyboard 220, a display panel 230, a network interface (I/F) 240, and a capturing mechanism 250. The controller 210 includes a main controller 200, an operation display controller 201, an input and output controller 202, and a capturing controller 203.

The mouse/keyboard 220 is an input interface used to directly operate the client communication terminal 2 or to input data to the projector 1. The mouse/keyboard 220 is implemented by the control device 15 illustrated in FIG. 2.

The display panel 230 is an output interface on which the status of the client communication terminal 2 is visually displayed, and also is an input interface such as a touch panel used by a user to directly operate the client communication terminal 2 or to input data to the client communication terminal 2. Moreover, the display panel 230 may display an image to accept a user operation. The display panel 230 is implemented by the control device 15 and the display 16 illustrated in FIG. 2.

The network interface 240 is an interface used to enable the client communication terminal 2 to communicate with other devices such as the projector 1 through the network, and the Ethernet (registered trademark), a universal serial bus (USB), Bluetooth (registered trademark), Wi-Fi (registered trademark), FeliCa (registered trademark), PCIe, an interface manufactured under the IEEE standard, or the like are used as the network interface 240. The network interface 240 is implemented by the communication interface 17 illustrated in FIG. 2.

The controller 210 is configured by a combination of software and hardware. More specifically, a program that is stored in a storage medium such as the ROM 12 and the HDD 13 is loaded into the RAM 11 by the CPU 10, and the controller 210 is configured by a combination of hardware such as an integrated circuit and a software controller configured by the computation performed by the CPU 10 according to the program.

The main controller 200 controls each element of the controller 210, and gives a command to each element of the controller 210. The main controller 200 controls the input and output controller 202, and accesses other devices through the network interface 240.

The operation display controller 201 controls the display panel 230 to display an image under the control of the main controller 200, or inputs data, a signal, or a command, which are input through the mouse/keyboard 220 or the display panel 230, to the main controller 200. Then, the main controller 200 gives a command to each element of the controller 210 according to the data, signal, or the command input by the operation display controller 201.

The input and output controller 202 sends data, a signal, or a command to other devices through the network interface 240 under the control of the main controller 200, or inputs the data, signal, or the command, which are input through the network interface 240, to the main controller 200. Then, the main controller 200 gives a command to each element of the controller 210 according to the data, signal, or the command input by the input and output controller 202.

The capturing controller 203 controls or drives the capturing mechanism 250 under the control of the main controller 200. The image capturing unit 204 captures the moving images that are being displayed on the display panel 230 as captured images, under the control of the main controller 200.

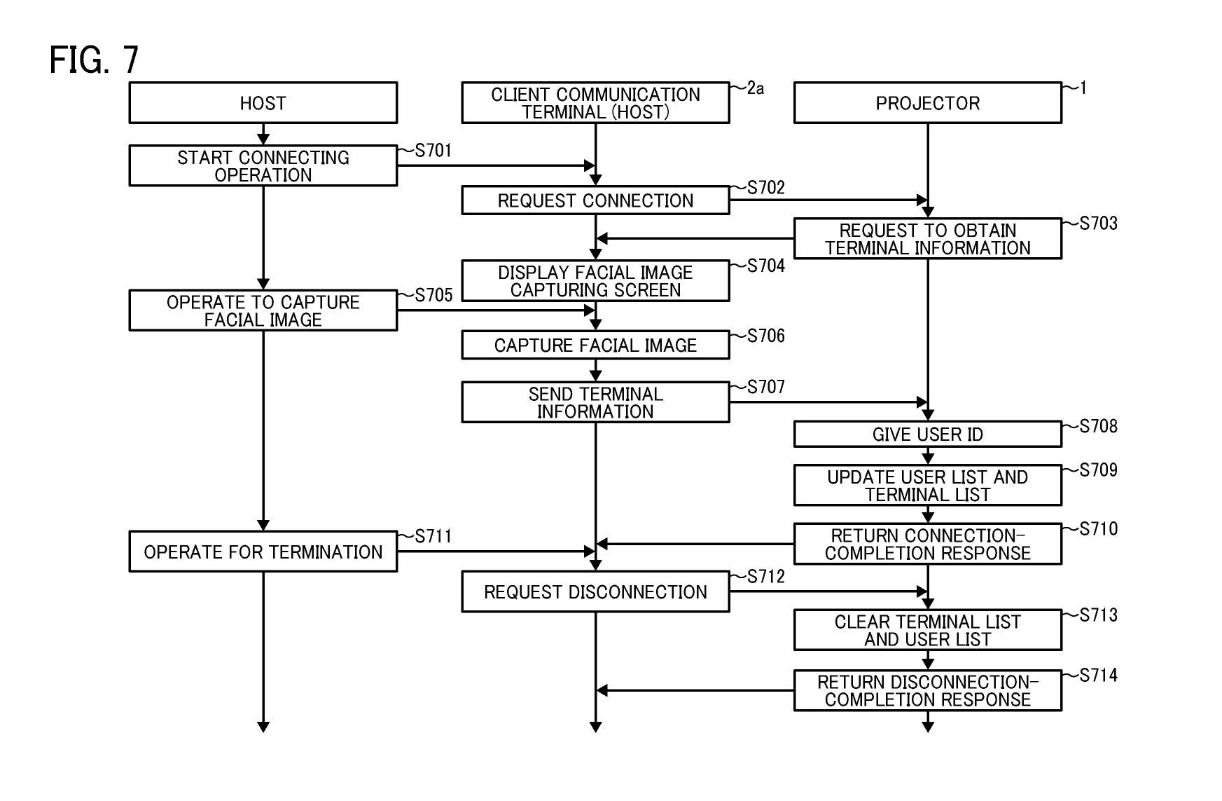

FIG. 7 is a sequence diagram of processes in which a user of the video display system according to the present embodiment connects the client communication terminal 2 of the user to the projector 1.

In FIG. 7, processes in which the client communication terminal 2a that the host operates is connected to the projector 1 are described. Note that processes in which the client communication terminals 2b to 2z that participants operate are connected to the projector 1 are similar to the processes that are described with reference to FIG. 7.

Note also that the client communication terminal 2a that the host operates is connected to the projector 1 in a host mode, and that the client communication terminals 2b to 2z that the participants operate is connected to the projector 1 in a participant mode. Due to this configuration, the projector 1 can distinguish between the client communication terminal 2a that the host operates and the client communication terminals 2b to 2z that the participants operate.

As illustrated in FIG. 7, the client communication terminal 2 that a user of the video display system according to the present embodiment operates is connected to the projector 1 as follows. Once the host starts the connecting operation of the client communication terminal 2a to the projector 1 (S701), firstly, the client communication terminal 2a requests connection to the projector 1 (S702).

Then, the projector 1 accepts the connection request from the client communication terminal 2a, and requests the client communication terminal 2a that is the request sender to obtain terminal information (S703).

Then, the client communication terminal 2a accepts the request to obtain terminal information from the projector 1, and activates a capturing mode to display a facial image capturing screen for capturing the facial image of the host (S704).

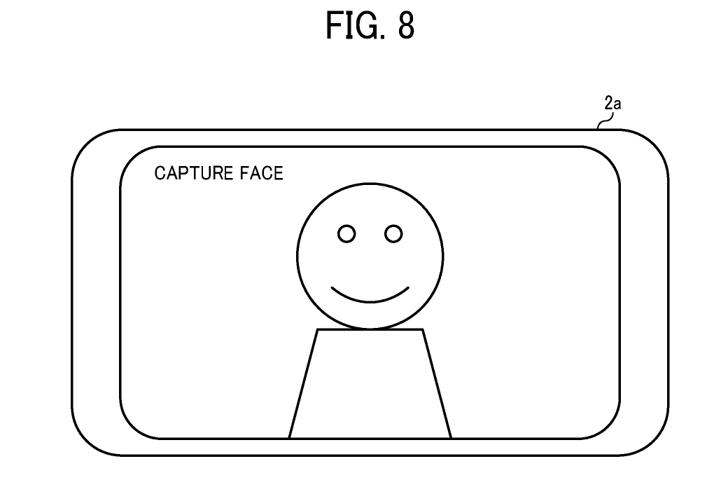

FIG. 8 is a diagram illustrating a facial image capturing screen displayed on the client communication terminal 2, according to the present embodiment. As illustrated in FIG. 8, on a facial image capturing screen displayed on the client communication terminal 2 according to the present embodiment, a message prompting the user to capture a facial image is displayed together with the images captured by the capturing mechanism 250.

When the host operates the facial image capturing screen to capture a facial image (S705), the client communication terminal 2a captures the facial image of the host (S706), and sends the terminal information including the captured facial image and its own IP address as a set to the projector 1 (S707).

Then, the projector 1 applies user ID to the facial image of the terminal information sent from the client communication terminal 2a (S708), and updates the user list and the terminal list that are managed by the user manager 105 and the terminal manager 106, respectively (S709).

Then, the projector 1 returns a connection-completion response to the client communication terminal 2a that is the request sender (S710).

After that, when the host operates for termination (S711), the client communication terminal 2a sends a disconnection request to the projector 1 (S712).

In response to the disconnection request, the projector 1 clears the user list and the terminal list that are managed by the user manager 105 and the terminal manager 106, respectively (S713), and returns a disconnection-completion response to the client communication terminal 2a that is the request sender (S714).

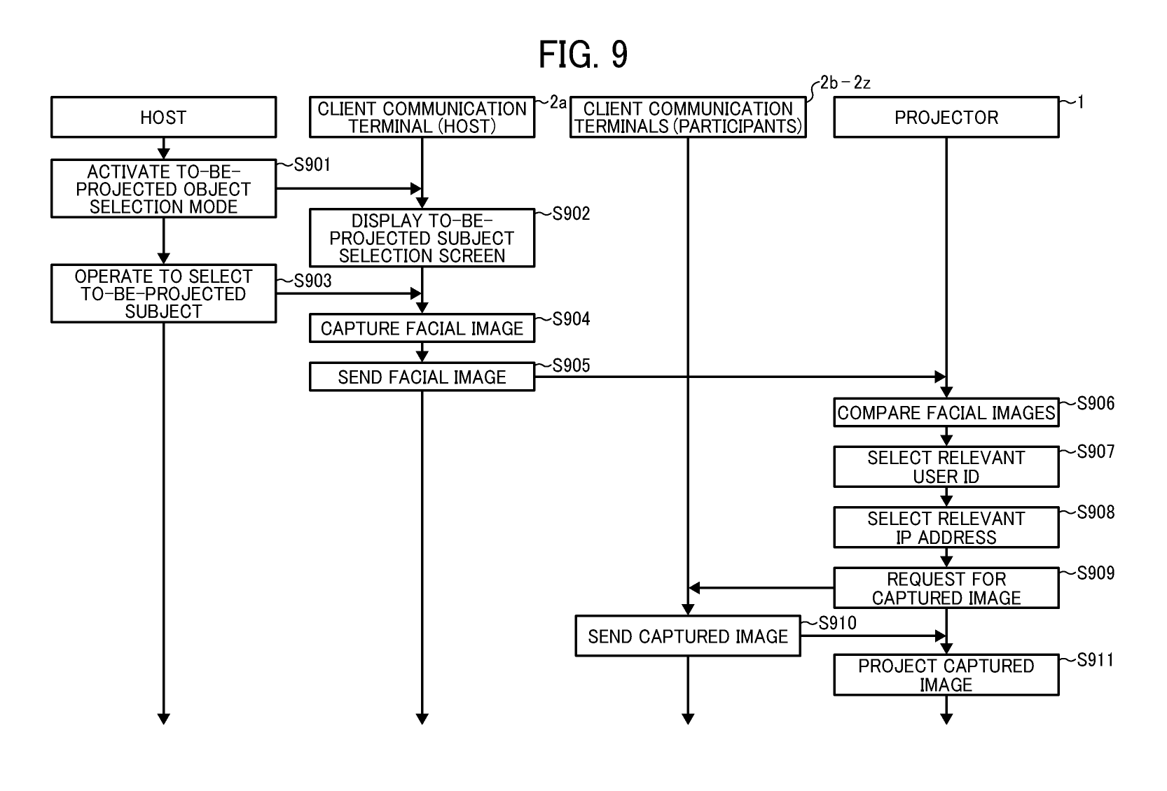

FIG. 9 is a diagram illustrating processes in which the projector 1 according to the present embodiment projects an image captured by the client communication terminal 2.

As illustrated in FIG. 9, when the projector 1 according to the present embodiment projects an image captured by the client communication terminal 2, processes are performed as follows. Once the host activates a to-be-projected subject selection mode (S901), firstly, the client communication terminal 2a displays a to-be-projected subject selection screen to select a participant who operates the client communication terminal 2 from which a captured image is to be projected (S902).

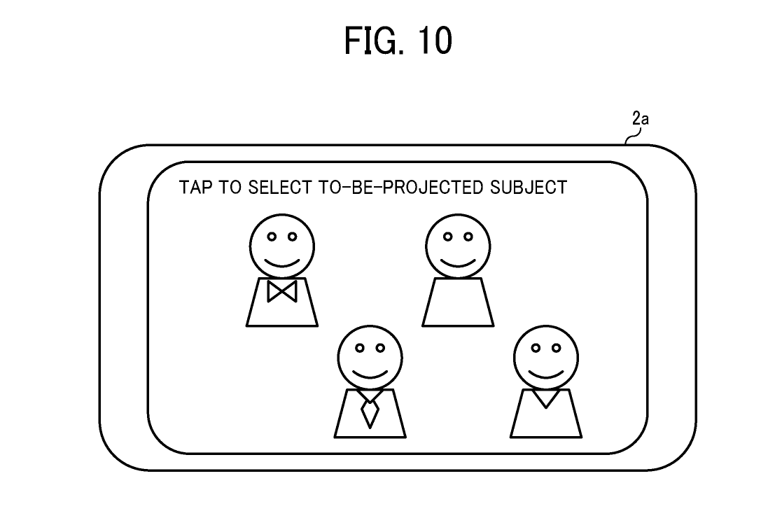

FIG. 10 is a diagram illustrating a to-be-projected subject selection screen displayed on the client communication terminal 2, according to the present embodiment. As illustrated in FIG. 10, on the to-be-projected subject selection screen displayed on the client communication terminal 2 according to the present embodiment, a message prompting the user to select a participant who operates the client communication terminal 2 from which a captured image is to be projected is displayed together with the images captured by the capturing mechanism 250. In other words, in the present embodiment, the capturing mechanism 250 serves as a capturing unit.

Once a participant who operates the client communication terminal 2 from which a captured image is to be projected is selected on the to-be-projected subject selection screen by the host (S903), the client communication terminal 2a uses the capturing mechanism 250 to capture the facial image of the selected participant (S904), and sends the captured facial image to the projector 1 (S905).

Then, the projector 1 uses the facial image comparator 107 to compare a facial image sent from the client communication terminal 2a with the facial images that are registered to a user list managed by the user manager 105 (S906), and selects the user ID associated with the facial image that best matches the extracted facial image from the user list managed by the user manager 105 (S907). In this configuration according to the present embodiment, the main controller 100 serves as a facial image acquisition unit.

Then, the projector 1 uses the projection selector 108 to select the IP address that is associated with the user ID selected in S907, from the terminal list managed by the terminal manager 106 (S908), and sends a captured-image obtaining request to the client communication terminal 2 that corresponds to the selected IP address (S909). In other words, in the present embodiment, the projection selector 108 serves as an information processing device selector, and an IP address is used as location identification information to identify the location of the client communication terminals 2 on the network 4.

Then, the client communication terminal 2 that has received the captured-image obtaining request uses the image capturing unit 204 to capture images and generates a video signal based on the captured images, and sends the generated video signal to the projector 1 (S910).

Then, after the video signal of the captured images is sent from the client communication terminal 2, the projector 1 projects the captured images of the client communication terminal 2 based on the received video signal of the captured images (S911). In this configuration, the main controller 100 serves as a video signal acquisition unit.

As described above, the video display system according to the present embodiment associates the IP addresses of the client communication terminals 2b to 2z with the facial images of the participants who operate these communication terminals 2b to 2z, and produces a list in advance.

Then, in the video display system according to the present embodiment, the host uses the client communication terminal 2a of his/her own to capture a facial image of the participant who operates the client communication terminal 2 from which a captured image is to be projected, and the IP address that is associated with the captured facial image is selected from the above produced list. Then, in the video display system according to the present embodiment, the projector 1 projects the image that is captured by the client communication terminal 2 associated with the IP address as selected above.

Due to this configuration of the video display system according to the present embodiment, when the client communication terminal 2 from which a captured image is to be projected is to be selected, the only thing that the host has to do is to capture the facial image of the participant who operates the target client communication terminal 2. In other words, the host no longer has to seek a target client communication terminal 2 on his/her own from the list of a plurality of client communication terminals 2. Accordingly, the video display system according to the present embodiment can improve customer convenience.

In the video display system according to the present embodiment, the projector 1 and the client communication terminals 2 are connected to each other through the network. However, the video display system according to the present embodiment may further include a server that is connected to the same network or a different network that is connected to the same network through public lines, and the server may be provided with functions that are equivalent to the user manager 105, the terminal manager 106, the facial image comparator 107, and the projection selector 108.

### Second Embodiment

In the video display system according to the first embodiment, a host or a participant has to capture a facial image every time the client communication terminal 2 is to be connected to the projector 1. This is because the video display system according to the first embodiment has to associate a facial image with the latest IP address as an IP address may be changed every time the client communication terminal 2 is connected to the network.

In the video display system according to the present embodiment, firstly, the client communication terminal 2b to 2z that participants operate are registered to the projector 1. In such registration processes, the video display system according to the present embodiment associates the media access control (MAC) addresses of the client communication terminals 2b to 2z with the facial images of the participants who operate these communication terminals 2b to 2z, and produces a list in advance.

Due to this configuration, the registration processes do not have to be repeated afterward in the video display system according to the present embodiment unless the host or participants are changed or newly added. This is because a MAC address is unique to each of the client communication terminals 2 and is never changed.

Then, the video display system according to the present embodiment obtains a MAC address and an IP address from each of the client communication terminals 2 when the client communication terminal 2 is connected to the projector 1, and associates the obtained IP address with one of the MAC addresses, registered to the above list, that is the same as the MAC address obtained together with the IP address. Accordingly, the latest IP address and a facial image are associated with each other in the above list.

Then, in the video display system according to the present embodiment, the host uses the client communication terminal 2a of his/her own to capture a facial image of the participant who operates the client communication terminal 2 from which a captured image is to be projected, and the IP address that is associated with the captured facial image is selected from the above produced list. Then, in the video display system according to the present embodiment, the projector 1 projects the image that is captured by the client communication terminal 2 associated with the IP address as selected above.

Due to this configuration, in the video display system according to the present embodiment, a host or a participant no longer has to capture a facial image every time the client communication terminal 2 is to be connected to the projector 1. Accordingly, the video display system according to the present embodiment can further improve customer convenience.

Embodiments of the present invention are described below in detail with reference to the drawings. Note that like reference signs are given to elements similar to those described in the first embodiment, and their detailed description is omitted.

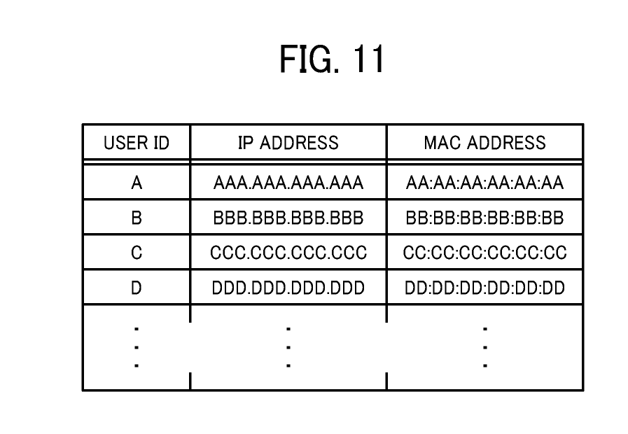

FIG. 11 is a diagram illustrating a terminal list that the terminal manager 106 of the projector 1 manages, according to the present embodiment.

As illustrated in FIG. 11, in the terminal list that the terminal manager 106 of the projector 1 according to the present embodiment manages, the IP addresses of the client communication terminals 2, the MAC addresses of the client communication terminals 2, and the user ID of the users who operate these client communication terminals 2 are associated with each other.

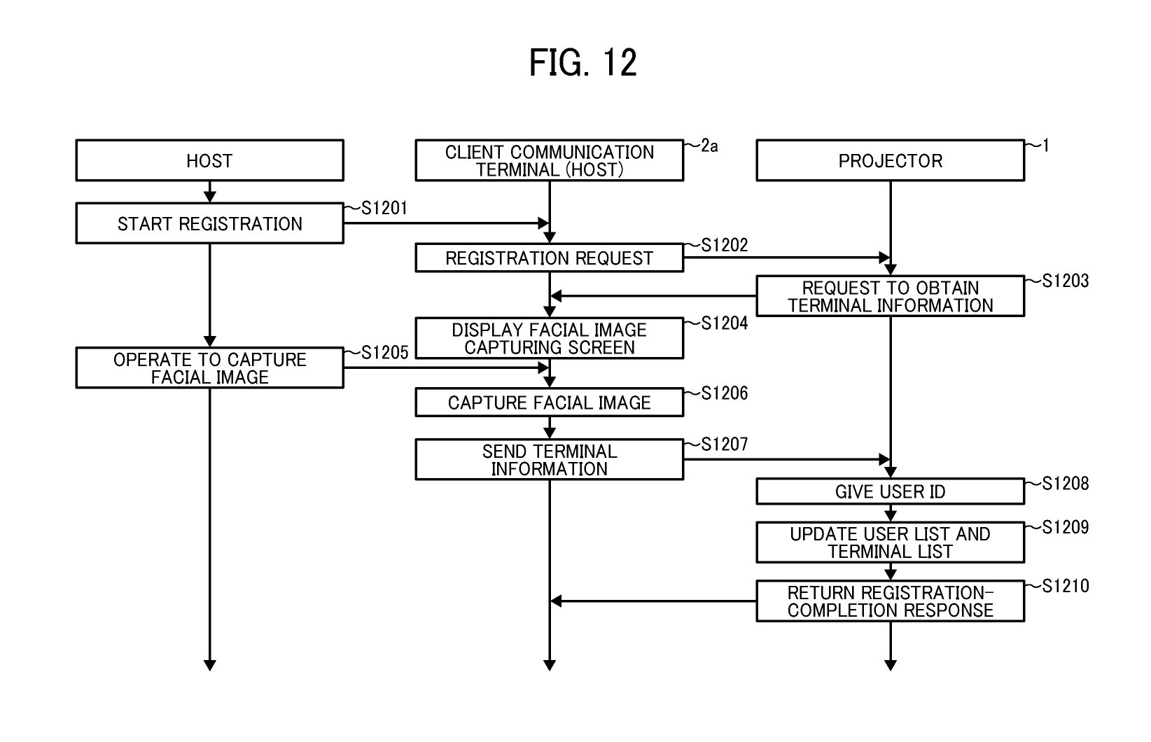

FIG. 12 is a sequence diagram illustrating processes in which a user of the video display system according to the present embodiment registers the client communication terminal 2 of the user to the projector 1.

In FIG. 12, processes in which the client communication terminal 2a that the host operates is registered to the projector 1 are described. Note that processes in which the client communication terminals 2b to 2z that participants operate are registered to the projector 1 are similar to the processes that are described with reference to FIG. 12.

Note also that the client communication terminal 2a that the host operates is registered to the projector 1 in a host mode, and that the client communication terminals 2b to 2z that the participants operate is registered to the projector 1 in a participant mode. Due to this configuration, the projector 1 can distinguish between the client communication terminal 2a that the host operates and the client communication terminals 2b to 2z that the participants operate.

As illustrated in FIG. 12, the client communication terminal 2 that a user of the video display system according to the present embodiment operates is registered to the projector 1 as follows. Once the host starts the registration operation of the client communication terminal 2a to the projector 1 (S1201), firstly, the client communication terminal 2a requests registration to the projector 1 (S1202).

Then, the projector 1 accepts the registration request from the client communication terminal 2a, and requests the client communication terminal 2a that is the request sender to obtain terminal information (S1203).

Then, the client communication terminal 2a accepts the request to obtain terminal information from the projector 1, and activates a capturing mode to display a facial image capturing screen for capturing the facial image of the host (S1204). Note that the facial image capturing screen is described as above with reference to FIG. 8.

When the host operates the facial image capturing screen to capture a facial image (S1205), the client communication terminal 2a captures the facial image of the host (S1206), and sends the terminal information including the captured facial image and its own MAC address to the projector 1 (S1207).

Then, the projector 1 applies user ID to the facial image of the terminal information sent from the client communication terminal 2a (S1208), and updates the user list and the terminal list that are managed by the user manager 105 and the terminal manager 106, respectively (S1209). In this configuration, the main controller 100 serves as an association information registration unit.

Then, the projector 1 returns a registration-completion response to the client communication terminal 2a that is the request sender (S1210).

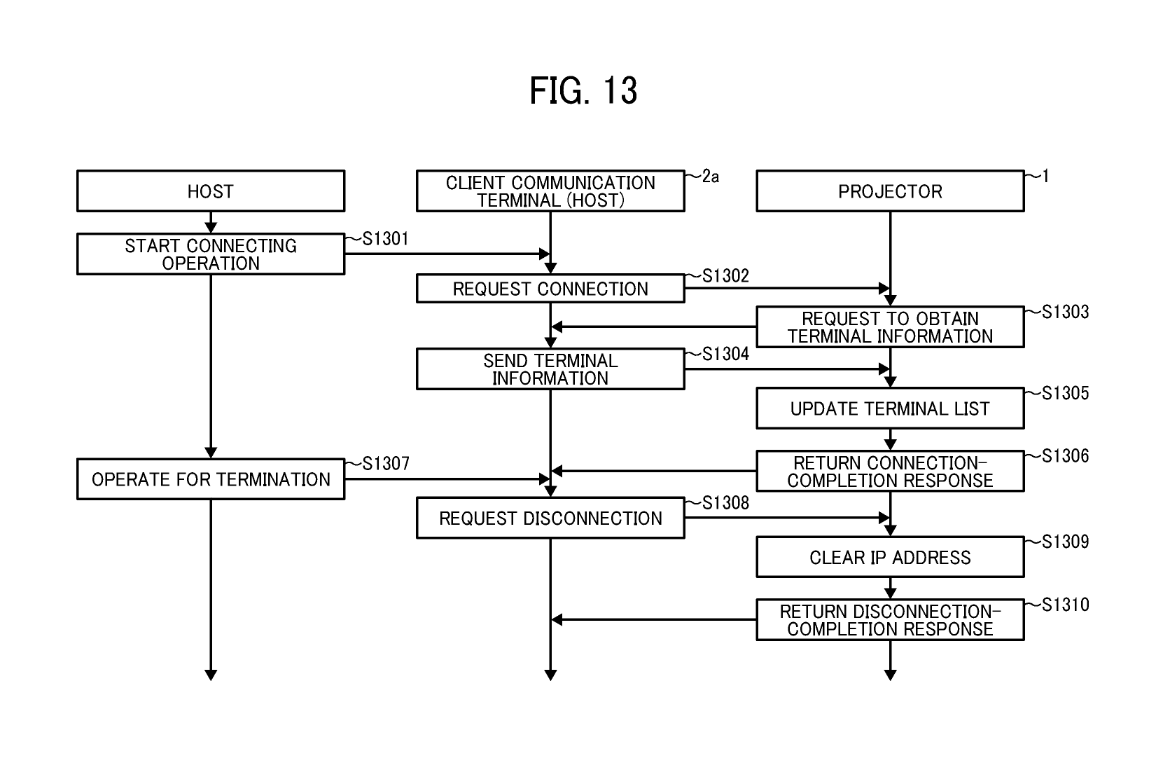

FIG. 13 is a sequence diagram of processes in which a user of the video display system according to the present embodiment connects the client communication terminal 2 of the user to the projector 1.

In FIG. 13, processes in which the client communication terminal 2a that the host operates is connected to the projector 1 are described. Note that processes in which the client communication terminals 2b to 2z that participants operate are connected to the projector 1 are similar to the processes that are described with reference to FIG. 13.

Note also that the client communication terminal 2a that the host operates is connected to the projector 1 in a host mode, and that the client communication terminals 2b to 2z that the participants operate is connected to the projector 1 in a participant mode. Due to this configuration, the projector 1 can distinguish between the client communication terminal 2a that the host operates and the client communication terminals 2b to 2z that the participants operate.

As illustrated in FIG. 13, the client communication terminal 2 that a user of the video display system according to the present embodiment operates is connected to the projector 1 as follows. Once the host starts the connecting operation of the client communication terminal 2a to the projector 1 (S1301), firstly, the client communication terminal 2a requests connection to the projector 1 (S1302).

Then, the projector 1 accepts the connection request from the client communication terminal 2a, and requests the client communication terminal 2a that is the request sender to obtain terminal information (S1303).

Then, the client communication terminal 2a sends the terminal information including its own IP address and MAC address as a set to the projector 1 (S1304).

Once the terminal information is sent from the client communication terminal 2a, the projector 1 associates the obtained IP address with one of the MAC addresses, registered to the terminal list stored in the terminal manager 106, that is the same as the MAC address sent together with the IP address. Accordingly, the terminal list is updated (S1305), and facial images are associated with the latest IP addresses in the terminal list. In other words, in the present embodiment, MAC addresses are used as individual identification information for identifying information processing devices individually. In this configuration, the main controller 100 and the terminal manager 106 serve as a location identification information acquisition unit and an associating unit, respectively.

Then, the projector 1 returns a connection-completion response to the client communication terminal 2a that is the request sender (S1306).

After that, when the host operates for termination (S1307), the client communication terminal 2a sends a disconnection request to the projector 1 (S1308).

In response to the disconnection request, the projector 1 clears only the IP addresses in the terminal list that is managed by the terminal manager 106 (S1309), and returns a disconnection-completion response to the client communication terminal 2a that is the request sender (S1310).

As described above, firstly, the video display system according to the present embodiment associates the MAC addresses of the client communication terminals 2b to 2z with the facial images of the participants who operate these communication terminals 2b to 2z, and produces a list in advance. By so doing, the client communication terminals 2 are registered to the video display system. Due to this configuration, the registration processes do not have to be repeated afterward in the video display system according to the present embodiment unless the host or participants are changed or newly added. This is because a MAC address is unique to each of the client communication terminals 2 and is never changed.

Then, the video display system according to the present embodiment obtains a MAC address and an IP address from each of the client communication terminals 2 when the client communication terminal 2 is connected to the projector 1, and associates the obtained IP address with one of the MAC addresses, registered to the above list, that is the same as the MAC address obtained together with the IP address. Accordingly, the latest IP address and a facial image are associated with each other in the above list.

Then, in the video display system according to the present embodiment, the host uses the client communication terminal 2a of his/her own to capture a facial image of the participant who operates the client communication terminal 2 from which a captured image is to be projected, and the IP address that is associated with the captured facial image is selected from the above produced list. Then, in the video display system according to the present embodiment, the projector 1 projects the image that is captured by the client communication terminal 2 associated with the IP address as selected above.

Due to this configuration, in the video display system according to the present embodiment, a host or a participant no longer has to capture a facial image every time the client communication terminal 2 is to be connected to the projector 1. Accordingly, the video display system according to the present embodiment can further improve customer convenience.

The processes in which the projector 1 according to the present embodiment projects an image captured by the client communication terminal 2 are described as above with reference to FIG. 9.

### Third Embodiment

In the video display system according to the first and second embodiments, a host or a participant has to connect the client communication terminal 2 of his/her own to the projector 1 on an as-needed basis.

In order to deal with such a situation, firstly, the video display system according to the present embodiment associates the MAC addresses of the client communication terminals 2b to 2z with the facial images of the participants who operate these communication terminals 2b to 2z, and produces a list in advance. Further, the video display system according to the present embodiment generates an address resolution protocol (ARP) table to obtain a MAC address from the IP address of each of the client communication terminals 2b to 2z in advance.

Then, the video display system according to the present embodiment obtains from the DHCP server 3 the IP addresses of the client communication terminals 2 that are connected to the network with the same segment, and broadcast an ARP request to the obtained IP addresses.

Then, the video display system according to the present embodiment associates the IP addresses to which an ARP request has been sent with one of the MAC addresses, registered to the ARP table, that is the same as the MAC address obtained by broadcasting the ARP request. Accordingly, the ARP table is completed.

Then, in the video display system according to the present embodiment, the host uses the client communication terminal 2a of his/her own to capture a facial image of the participant who operates the client communication terminal 2 from which a captured image is to be projected, and the MAC address that is associated with the captured facial image is selected from the above produced list.

Then, the video display system according to the present embodiment selects the IP address that is associated with one of the MAC addresses, registered to the ARP table, that is the same as the MAC address selected based on the facial image. Then, in the video display system according to the present embodiment, the projector 1 projects the image that is captured by the client communication terminal 2 associated with the IP address as selected above.

In the video display system according to the present embodiment, a host or a participant no longer has to connect the client communication terminal 2 of his/her own to the projector 1 on an as-needed basis. Accordingly, the video display system according to the present embodiment can further improve customer convenience.

Embodiments of the present invention are described below in detail with reference to the drawings. Note that like reference signs are given to elements similar to those described in the first and second embodiments, and their detailed description is omitted.

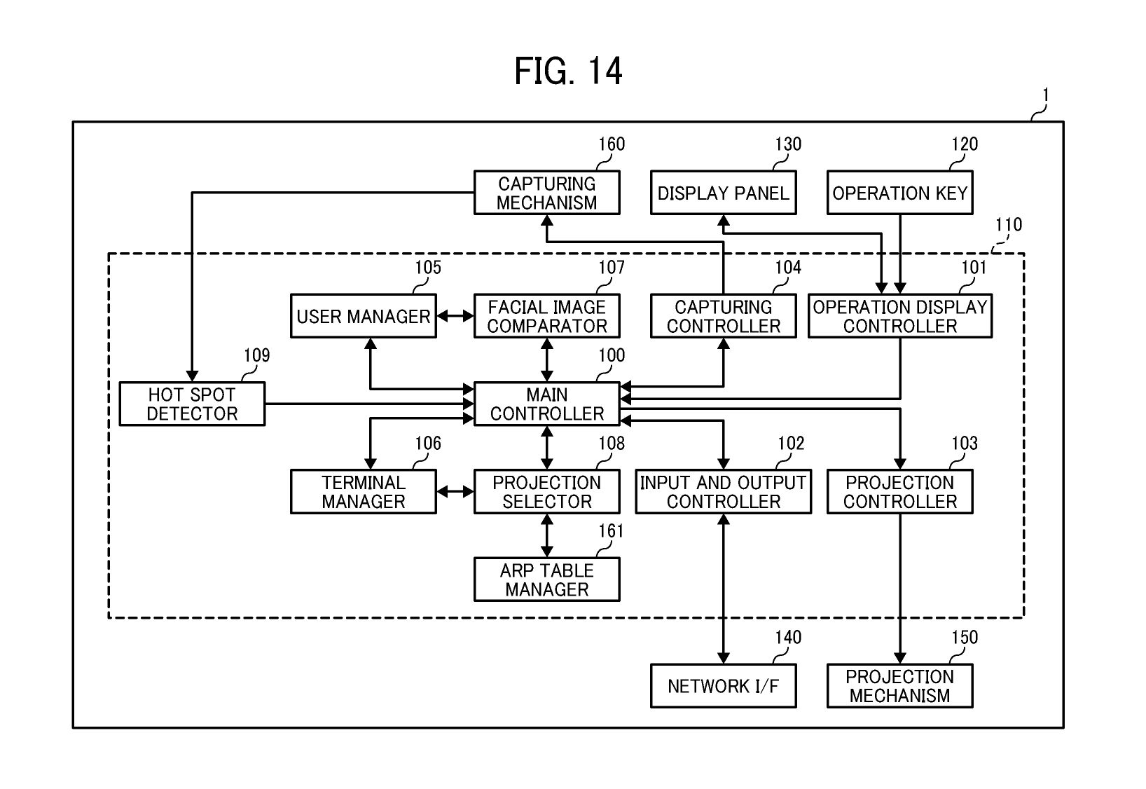

FIG. 14 is a schematic block diagram illustrating a functional configuration of the projector 1 according to the present embodiment. As illustrated in FIG. 14, the projector 1 according to the present embodiment further includes an ARP table manager 161 in addition to the elements described above in the first and second embodiments.

The ARP table manager 161 is used to obtain a MAC address from an IP address, and manages an ARP table in which the IP addresses and the MAC addresses of the client communication terminals 2 are associated with each other.

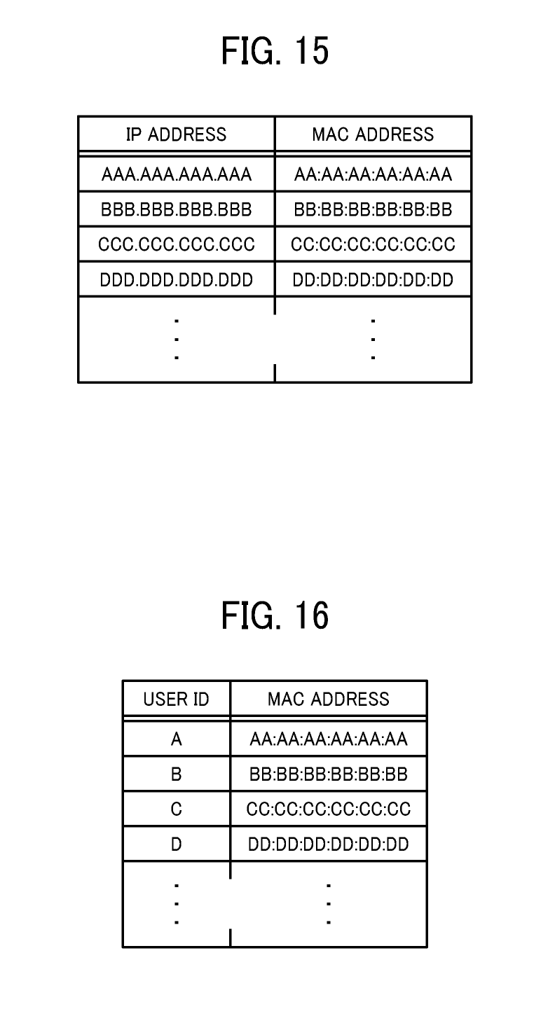

FIG. 15 is a diagram illustrating an ARP table that the projector 1 manages with the ARP table manager 161, according to the present embodiment.

FIG. 16 is a diagram illustrating a terminal list that the terminal manager 106 of the projector 1 manages, according to the present embodiment.

As illustrated in FIG. 16, in the terminal list that is managed by the terminal manager 106 of the projector 1 according to the present embodiment, the MAC addresses of the client communication terminals 2 are associated with the user ID of the users who operate these client communication terminals 2.

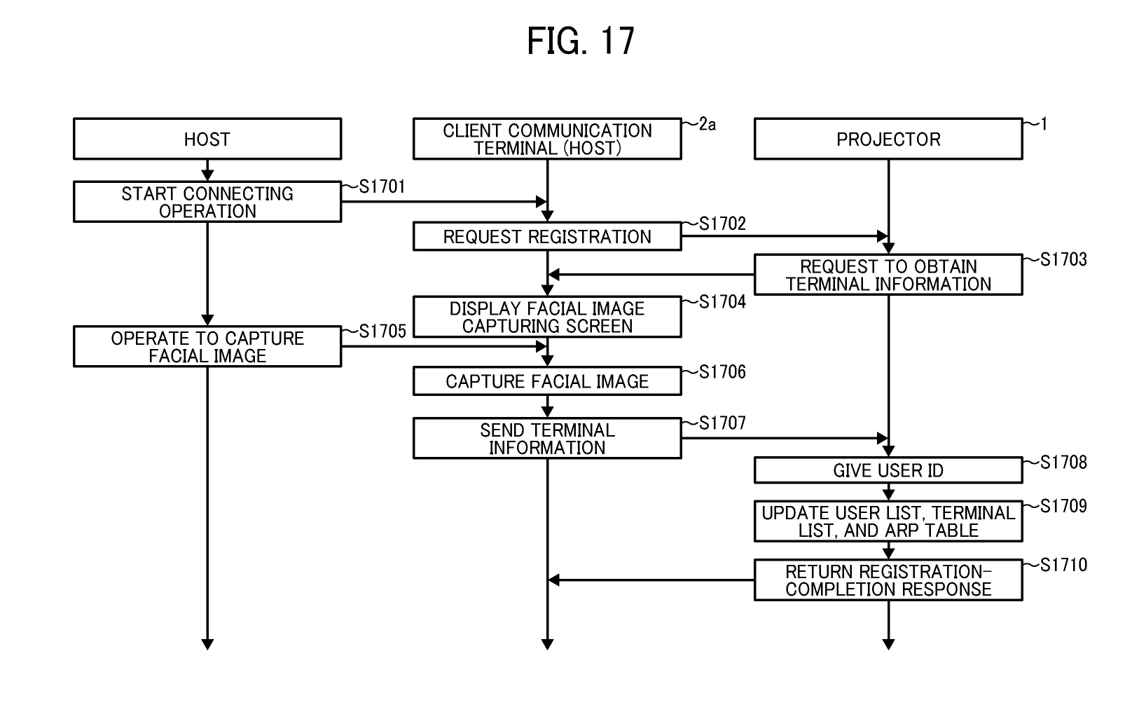

FIG. 17 is a sequence diagram of processes in which a user of the video display system according to the present embodiment registers the client communication terminal 2 of the user to the projector 1.

In FIG. 17, processes in which the client communication terminal 2a that the host operates is registered to the projector 1 are described. Note that processes in which the client communication terminals 2b to 2z that participants operate are registered to the projector 1 are similar to the processes that are described with reference to FIG. 17.

Note also that the client communication terminal 2a that the host operates is registered to the projector 1 in a host mode, and that the client communication terminals 2b to 2z that the participants operate is registered to the projector 1 in a participant mode. Due to this configuration, the projector 1 can distinguish between the client communication terminal 2a that the host operates and the client communication terminals 2b to 2z that the participants operate.

As illustrated in FIG. 17, the client communication terminal 2 that a user of the video display system according to the present embodiment operates is registered to the projector 1 as follows. Once the host starts the registration operation of the client communication terminal 2a to the projector 1 (S1701), firstly, the client communication terminal 2a requests registration to the projector 1 (S1702).

Then, the projector 1 accepts the registration request from the client communication terminal 2a, and requests the client communication terminal 2a that is the request sender to obtain terminal information (S1703).

Then, the client communication terminal 2a accepts the request to obtain terminal information from the projector 1, and activates a capturing mode to display a facial image capturing screen for capturing the facial image of the host (S1704). Note that the facial image capturing screen is described as above with reference to FIG. 8.

When the host operates the facial image capturing screen to capture a facial image (S1705), the client communication terminal 2a captures the facial image of the host (S1706), and sends the terminal information including the captured facial image and its own MAC address as a set to the projector 1 (S1707).

Then, the projector 1 applies user ID to the facial image of the terminal information sent from the client communication terminal 2a (S1708), and updates the user list, the terminal list, and the ARP table that are managed by the user manager 105, the terminal manager 106, and the ARP table manager 161, respectively (S1709). Note that the MAC addresses are registered to the ARP table, but the IP addresses are not registered to the ARP table at this point in time.

Then, the projector 1 returns a registration-completion response to the client communication terminal 2a that is the request sender (S1710).

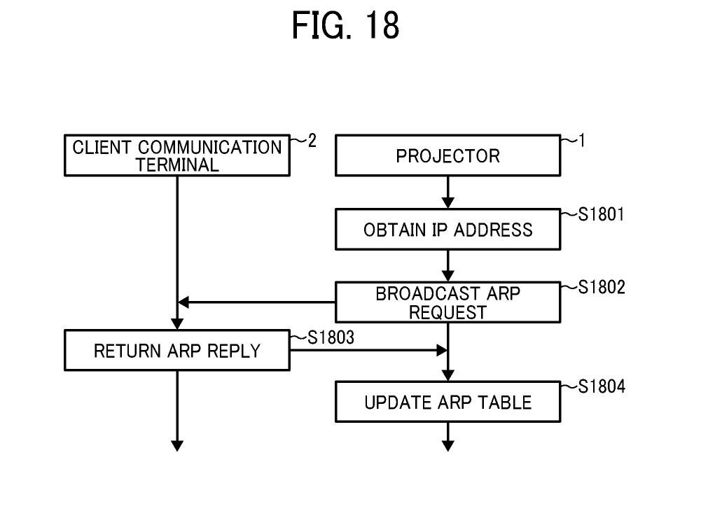

FIG. 18 is a sequence diagram illustrating processes of updating an ARP table that the ARP table manager 161 of the projector 1 manages, according to the present embodiment.

As illustrated in FIG. 18, the projector 1 according to the present embodiment updates an ARP table that the ARP table manager 161 manages, as follows. Firstly, the projector 1 obtains from the DHCP server 3 the IP addresses of the client communication terminals 2 that are connected to the network with the same segment (S1801), and broadcasts an ARP request to the obtained IP addresses (S1802).

Then, the client communication terminal 2 receives the ARP request, and uses an ARP reply to return the MAC address of its own to the projector 1 (S1803).

Then, the projector 1 associates the IP addresses to which an ARP request has been sent with one of the MAC addresses, registered to the ARP table managed by the ARP table manager 161, that is the same as the MAC address obtained by broadcasting the ARP request. Accordingly, the projector 1 updates the ARP table (S1804). Accordingly, the ARP table is completed.

The projector 1 repeats such update processes of the ARP table at regular time intervals. Accordingly, the latest IP addresses and the latest MAC addresses are associated with each other in the ARP table.

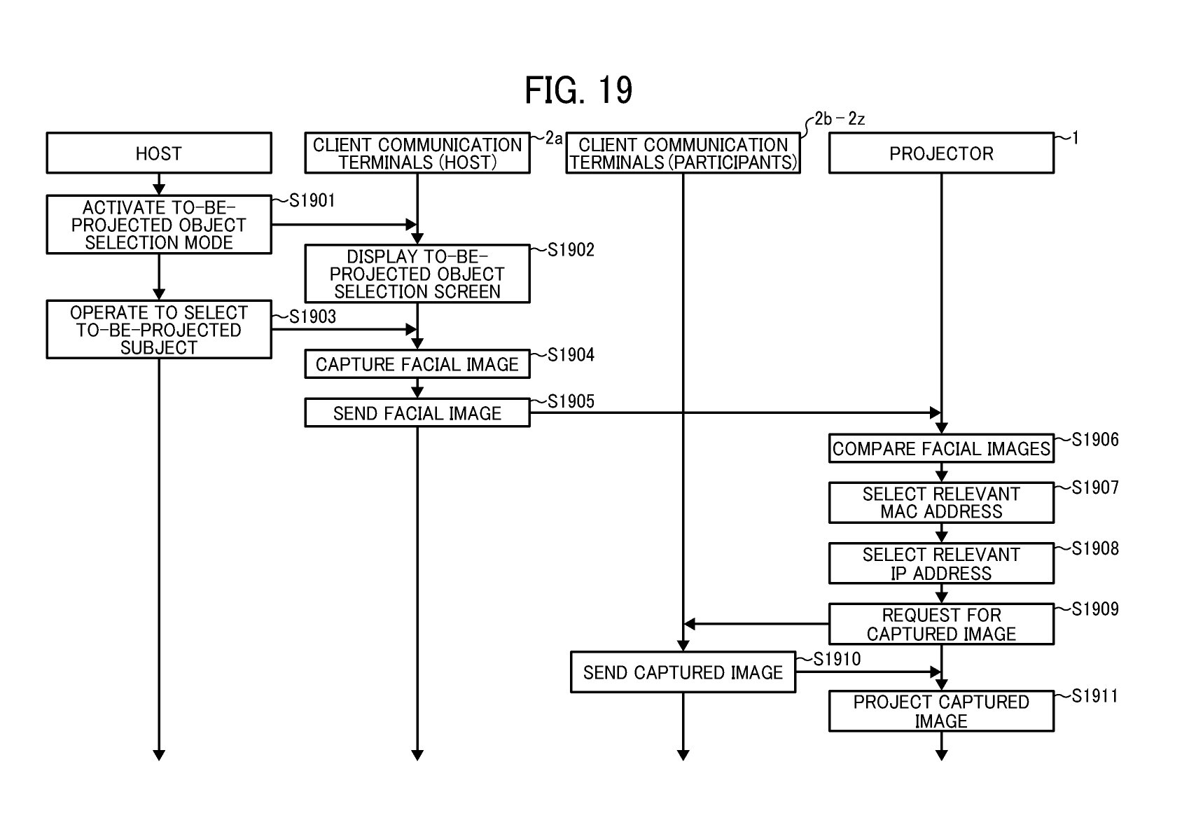

FIG. 19 is a diagram illustrating processes in which the projector 1 according to the present embodiment projects an image captured by the client communication terminal 2.

As illustrated in FIG. 19, when the projector 1 according to the present embodiment projects an image captured by the client communication terminal 2, processes are performed as follows. Once the host activates a to-be-projected subject selection mode (S1901), firstly, the client communication terminal 2a displays a to-be-projected subject selection screen to select a participant who operates the client communication terminal 2 from which a captured image is to be projected (S1902). Note that the to-be-projected subject selection screen is described as above with reference to FIG. 10.

Once a participant who operates the client communication terminal 2 from which a captured image is to be projected is selected on the to-be-projected subject selection screen by the host (S1903), the client communication terminal 2a uses the capturing mechanism 250 to capture the facial image of the selected participant (S1904), and sends the captured facial image to the projector 1 (S1905).

Then, the projector 1 uses the facial image comparator 107 to compare a facial image sent from the client communication terminal 2a with the facial images that are registered to a user list managed by the user manager 105 (S1906), and selects the MAC address associated with the facial image that best matches the extracted facial image from the terminal list managed by the terminal manager 106 (S1907).

Then, the projector 1 uses the projection selector 108 to select the IP address that is associated with the MAC address selected in S1907, from the ARP table managed by the ARP table manager 161 (S1908), and sends a captured-image obtaining request to the client communication terminal 2 that corresponds to the selected IP address (S1909).

Then, the client communication terminal 2 that has received the captured-image obtaining request uses the image capturing unit 204 to capture images and generates a video signal based on the captured images, and sends the generated video signal to the projector 1 (S1910).

Then, after the video signal of the captured images is sent from the client communication terminal 2, the projector 1 projects the captured images of the client communication terminal 2 based on the received video signal of the captured images (S1911).

As described above, firstly, the video display system according to the present embodiment associates the MAC addresses of the client communication terminals 2b to 2z with the facial images of the participants who operate these communication terminals 2b to 2z, and produces a list in advance. Further, the video display system according to the present embodiment generates an address resolution protocol (ARP) table to obtain a MAC address from the IP address of each of the client communication terminals 2b to 2z in advance.

Then, the video display system according to the present embodiment obtains from the DHCP server 3 the IP addresses of the client communication terminals 2 that are connected to the network with the same segment, and broadcast an ARP request to the obtained IP addresses.

Then, the video display system according to the present embodiment associates the IP addresses to which an ARP request has been sent with one of the MAC addresses, registered to the ARP table, that is the same as the MAC address obtained by broadcasting the ARP request. Accordingly, the ARP table is completed.

Then, in the video display system according to the present embodiment, the host uses the client communication terminal 2a of his/her own to capture a facial image of the participant who operates the client communication terminal 2 from which a captured image is to be projected, and the MAC address that is associated with the captured facial image is selected from the above produced list.

Then, the video display system according to the present embodiment selects the IP address that is associated with one of the MAC addresses, registered to the ARP table, that is the same as the MAC address selected based on the facial image. Then, in the video display system according to the present embodiment, the projector 1 projects the image that is captured by the client communication terminal 2 associated with the IP address as selected above.

In the video display system according to the present embodiment, a host or a participant no longer has to connect the client communication terminal 2 of his/her own to the projector 1 on an as-needed basis. Accordingly, the video display system according to the present embodiment can further improve customer convenience.

In the video display system according to the present embodiment, the projector 1 and the client communication terminals 2 are connected to each other through the network. However, the video display system according to the present embodiment may further include a server that is connected to the same network or a different network that is connected to the same network through public lines, and the server may be provided with functions that are equivalent to the user manager 105, the terminal manager 106, the facial image comparator 107, the projection selector 108, and the ARP table manager 161.

### Fourth Embodiment

In the video display system according to the first, second, and third embodiments, a host or a participant uses the client communication terminals 2 of his/her own to capture a facial image. For this reason, the client communication terminals 2a to 2z have to be provided with a capturing function in the video display system according to the first, second, and third embodiments.

In order to avoid such a situation, the video display system according to the present embodiment is configured such that a host or a participant can use the projector 1 to capture a facial image. Due to this configuration, in the video display system according to the present embodiment, the client communication terminals 2a to 2z do not have to be provided with a capturing function.

Embodiments of the present invention are described below in detail with reference to the drawings. Note that like reference signs are given to elements similar to those described in the first, second, and third embodiments, and their detailed description is omitted.

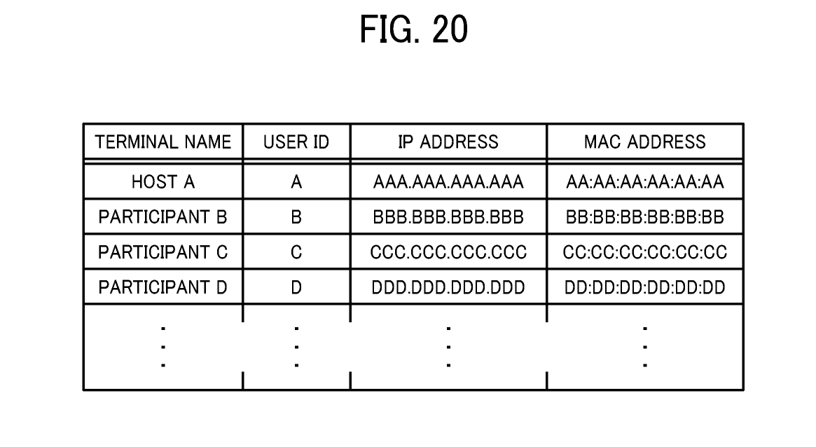

FIG. 20 is a diagram illustrating a terminal list that the terminal manager 106 of the projector 1 manages, according to the present embodiment.

As illustrated in FIG. 20, in the terminal list that is managed by the terminal manager 106 of the projector 1 according to the present embodiment, the terminal names, the IP addresses, and the MAC addresses of the client communication terminals 2 are associated with the user ID of the users who operate these client communication terminals 2.

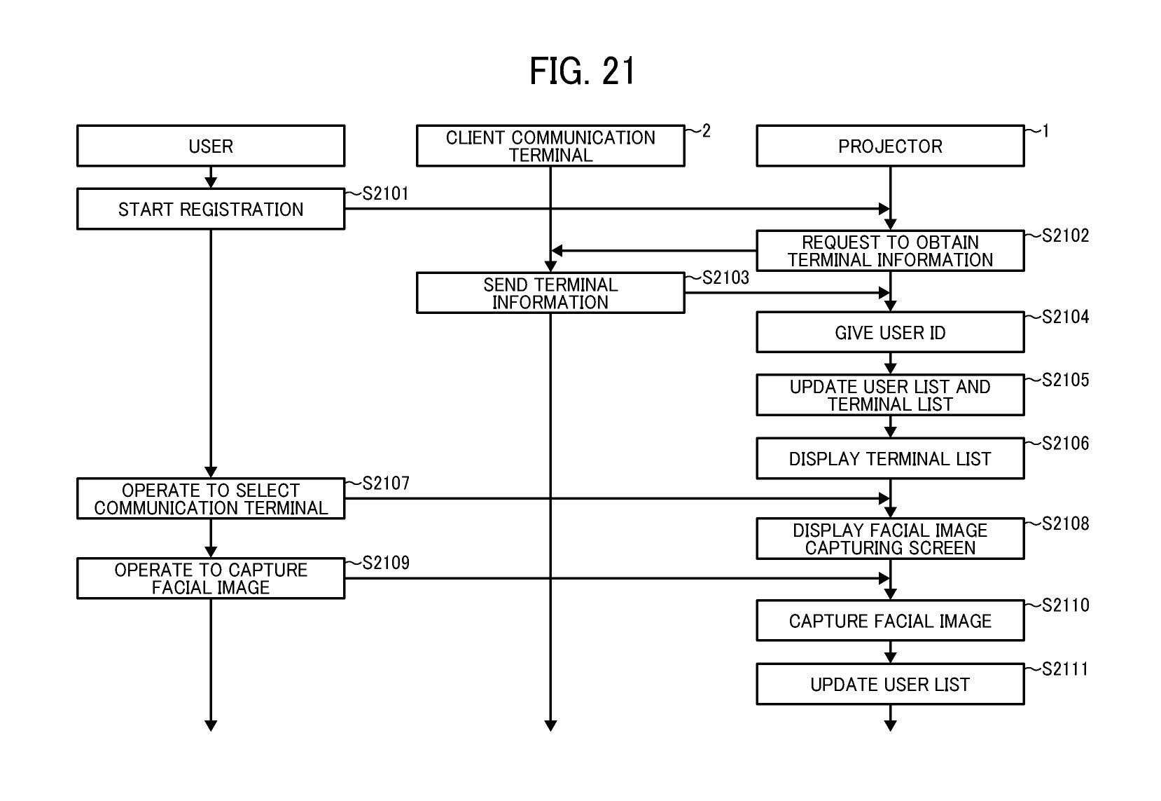

FIG. 21 is a sequence diagram of processes in which a user of the video display system according to the present embodiment registers the client communication terminal 2 of the user to the projector 1.

Note that the client communication terminal 2a that the host operates registers the projector 1 in a host mode, and that the client communication terminals 2b to 2z that the participants operate registers the projector 1 in a participant mode. Due to this configuration, the projector 1 can distinguish between the client communication terminal 2a that the host operates and the client communication terminals 2b to 2z that the participants operate.

As illustrated in FIG. 21, the client communication terminal 2 that a user of the video display system according to the present embodiment operates is registered to the projector 1 as follows. Once a user starts the registration operation of the client communication terminal 2 to the projector 1 (S2101), firstly, the projector 1 requests the client communication terminals 2 that are connected to the network with the same segment to obtain terminal information (S2102).

Then, upon receiving the request to obtain terminal information from the projector 1, the client communication terminal 2 sends the terminal information including its own terminal name, its own IP address, and its own MAC address as a set to the projector 1 (S2103).

Then, the projector 1 applies user ID to the facial image of the terminal information sent from the client communication terminal 2 (S2104), and updates the user list and the terminal list that are managed by the user manager 105 and the terminal manager 106, respectively (S2105).

Then, the projector 1 projects a terminal list screen including the terminal names, the user ID, the IP addresses, the MAC addresses, and the facial images that are registered to the user list and the terminal list that are managed by the user manager 105 and the terminal manager 106, respectively (S2106).

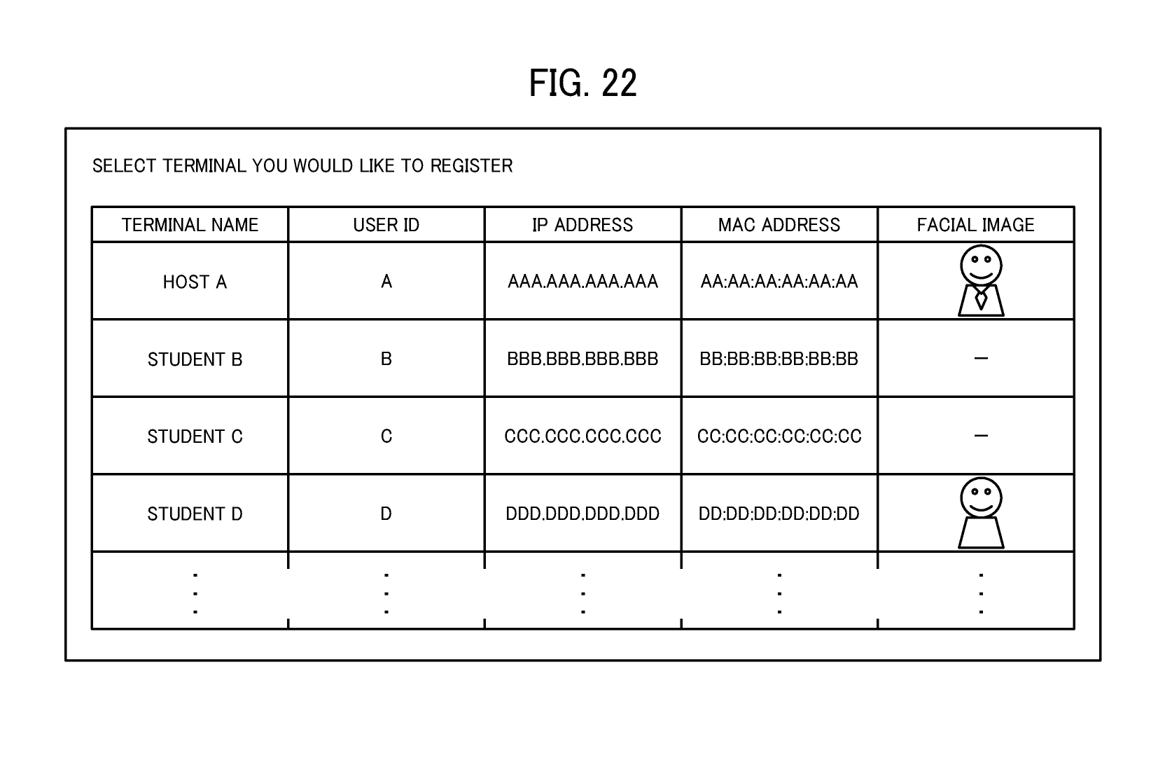

FIG. 22 is a diagram illustrating a terminal list screen displayed on the client communication terminal 2, according to the present embodiment.

Once a user operates the terminal list screen to select a communication terminal (S2107), the projector 1 activates a capturing mode to display a facial image capturing screen for capturing the facial image of the user (S2108). Note that the facial image capturing screen is described as above with reference to FIG. 8.

When the user operates the facial image capturing screen to capture a facial image (S2109), the projector 1 captures the facial image of the user (S2110).

Then, the projector 1 associates the facial image captured in S2110 with the user ID, which is registered to the user list managed by the user manager 105, that matches the user ID associated with the client communication terminal 2 selected in S2107 in the terminal list managed by the terminal manager 106. Accordingly, the user list is updated (S2111).

As described above, the video display system according to the present embodiment is configured such that a host or a participant can use the projector 1 to capture a facial image. Due to this configuration, in the video display system according to the present embodiment, the client communication terminals 2a to 2z do not have to be provided with a capturing function.

### Fifth Embodiment

The video display system according to the first, second, third, and fourth embodiments as described above is configured such that a host uses the client communication terminal 2a of his/her own to capture a facial image of the participant who operates the client communication terminal 2 from which a captured image is to be projected. For this reason, in the video display system according to the first, second, third, and fourth embodiments, the client communication terminal 2a has to be provided with a capturing function, and the host has to carry the client communication terminal 2a.

In order to deal with such a situation, the video display system according to the present embodiment is configured such that a host can use the projector 1 to capture a facial image of the participant who operates the client communication terminal 2 from which a captured image is to be projected. As the video display system according to the present embodiment is configured as above, the client communication terminal 2a does not have to be provided with a capturing function, or the host does not have to carry the client communication terminal 2a.

Embodiments of the present invention are described below in detail with reference to the drawings. Note that like reference signs are given to elements similar to those described in the first, second, third, and fourth embodiments, and their detailed description is omitted.

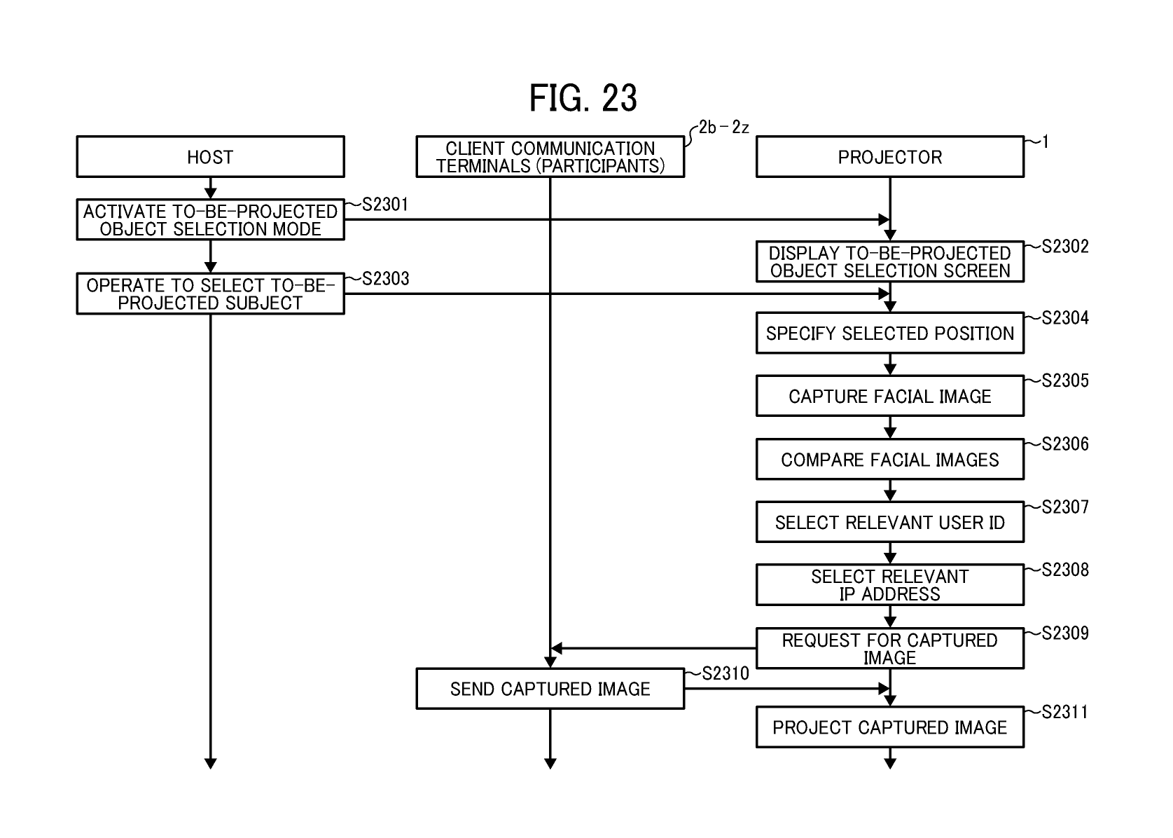

FIG. 23 is a diagram illustrating processes in which the projector 1 according to the present embodiment projects an image captured by the client communication terminal 2.

As illustrated in FIG. 23, when the projector 1 according to the present embodiment projects an image captured by the client communication terminal 2, processes are performed as follows. Once the host activates a to-be-projected subject selection mode (S2301), firstly, the client communication terminal 2a displays a to-be-projected subject selection screen to select a participant who operates the client communication terminal 2 from which a captured image is to be projected (S2302). Note that the to-be-projected subject selection screen is described as above with reference to FIG. 10.

Once a participant who operates the client communication terminal 2 from which a captured image is to be projected is selected on the to-be-projected subject selection screen by the host (S2303), the client communication terminal 2a uses the hot spot detector 109 to specify the position selected by the host (S2304).

Then, the projector 1 uses the capturing mechanism 250 to capture the facial image of the selected participant (S2305), and uses the facial image comparator 107 to compare the captured facial image with the facial images that are registered to a user list managed by the user manager 105 (S2306). Then, the projector 1 selects the user ID associated with the facial image that best matches the extracted facial image from the user list managed by the user manager 105 (S2307).

Then, the projector 1 uses the projection selector 108 to select the IP address that is associated with the user ID selected in S2307, from the terminal list managed by the terminal manager 106 (S2308), and sends a captured-image obtaining request to the client communication terminal 2 that corresponds to the selected IP address (S2309).

Then, the client communication terminal 2 that has received the captured-image obtaining request uses the image capturing unit 204 to capture images and generates a video signal based on the captured images, and sends the generated video signal to the projector 1 (S2310).

Then, after the video signal of the captured images is sent from the client communication terminal 2, the projector 1 projects the captured images of the client communication terminal 2 based on the received video signal of the captured images (S2311).

As described above, the video display system according to the present embodiment is configured such that a host can use the projector 1 to capture a facial image of the participant who operates the client communication terminal 2 from which a captured image is to be projected. As the video display system according to the present embodiment is configured as above, the client communication terminal 2a does not have to be provided with a capturing function, or the host does not have to carry the client communication terminal 2a.

### Sixth Embodiment

In the video display system according to the first to fifth embodiments, the projector 1 can project merely a single image captured by the client communication terminal 2 at once. Accordingly, in the video display system according to the first to fifth embodiments, a host and participants can view merely a single image captured by the client communication terminal 2 at once.

In order to deal with such a situation, in the video display system according to the present embodiment, the projector 1 is configured to project a plurality of images captured by the multiple client communication terminals 2 all at once. Due to such a configuration, in the video display system according to the present embodiment, a host and participants can view a plurality of images captured by the multiple client communication terminals 2 all at once.

Embodiments of the present invention are described below in detail with reference to the drawings. Note that like reference signs are given to elements similar to those described in the first to fifth embodiments, and their detailed description is omitted.

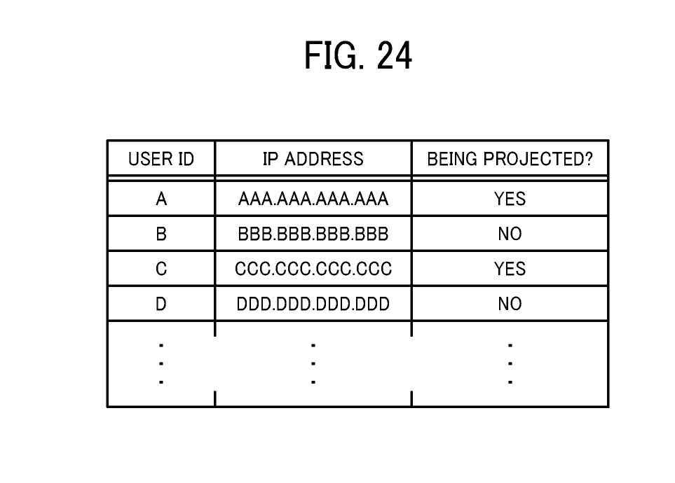

FIG. 24 is a diagram illustrating a terminal list that the terminal manager 106 of the projector 1 manages, according to the present embodiment.

As illustrated in FIG. 24, in the terminal list that is managed by the terminal manager 106 of the projector 1 according to the present embodiment, the IP addresses of the client communication terminals 2, the user ID of the users who operate these client communication terminals 2, and whether or not an image captured by the client communication terminal 2 is being projected are associated with each other. In FIG. 24, “YES” in the “BEING CAPTURED?” column indicates that an image captured by that client communication terminal 2 is being projected, and “NO” in “BEING CAPTURED?” column indicates that an image captured by that client communication terminal 2 is not being projected.

The projector 1 according to the present embodiment can refer to this terminal list to distinguish between the client communication terminal 2 from which a captured image is being projected and the client communication terminal 2 from which a captured image is not being projected. Accordingly, the projector 1 according to the present embodiment can avoid projecting multiple images captured by the same client communication terminal 2. In this configuration, the main controller 100 serves as a source determination unit.

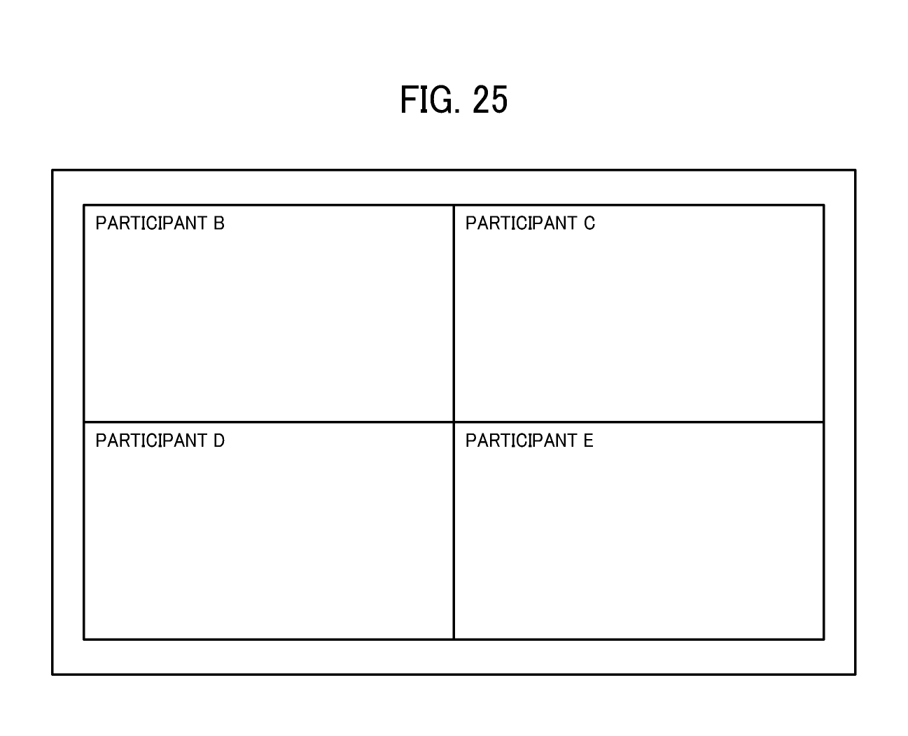

FIG. 25 is a diagram illustrating captured images that are projected on a projection plane by the projector 1 according to the present embodiment.

As illustrated in FIG. 25, the projector 1 according to the present embodiment can project a plurality of images captured by the multiple client communication terminals 2 all at once. FIG. 25 illustrates an example case in which four images captured by the client communication terminals 2 are projected at once. However, the projector 1 according to the present embodiment may be configured to project any greater number of images at once.

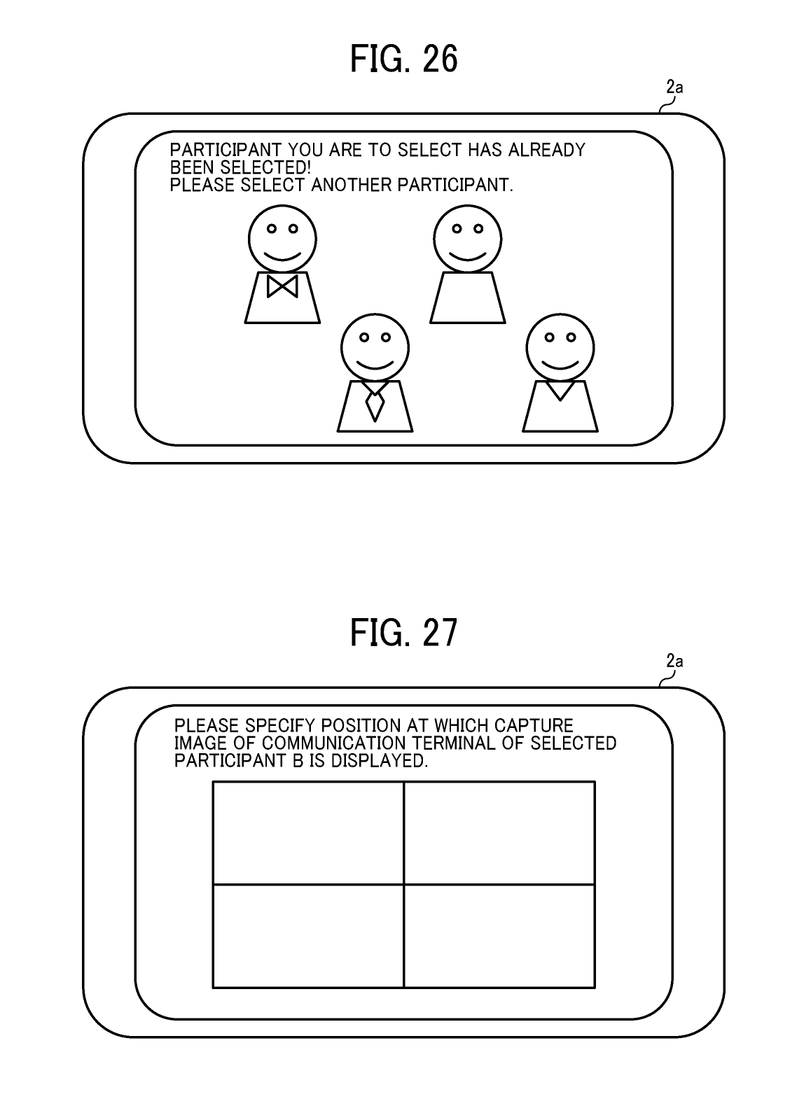

Next, cases in which the host erroneously operates the client communication terminal 2 of his/her own and selects again the participant who operates the client communication terminal 2 from which a captured image is being projected are described with reference to FIG. 26.

FIG. 26 is a diagram illustrating an impossible selection notification screen displayed on the client communication terminal 2, according to the present embodiment. Note that such an impossible selection notification screen is displayed when the host erroneously operates the client communication terminal 2 of his/her own and selects again the participant who operates the client communication terminal 2 from which a captured image is being projected.

As illustrated in FIG. 26, when the host erroneously operates the client communication terminal 2 of his/her own and selects again the participant who operates the client communication terminal 2 from which a captured image is being projected, a message appears to warn the host that the participant you are to select has already been selected.

Next, cases in which the host operates the client communication terminal 2a of his/her own to specify the position at which an image captured by the client communication terminal 2 that the selected participant operates is projected and displayed are described with reference to FIG. 27.

FIG. 27 is a diagram illustrating a display position selection screen displayed on the client communication terminal 2, according to the present embodiment. Here, the display position selection screen is displayed on the client communication terminal 2a that the host operates and is operated by the host to specify the position at which an image captured by the client communication terminal 2 that the selected participant operates is projected and displayed.

As illustrated in FIG. 27, the host can operate the display position selection screen to specify the position at which an image captured by the client communication terminal 2 that the selected participant operates is projected and displayed.

As described above, in the video display system according to the present embodiment, the projector 1 can project a plurality of images captured by the multiple client communication terminals 2 all at once. Due to this configuration, in the video display system according to the present embodiment, a host and participants can view a plurality of images captured by the multiple client communication terminals 2 all at once.

### Seventh Embodiment

In the video display system according to the first to sixth embodiments, the projector 1 is configured to project an image captured by the client communication terminal 2 of the participant selected by a host on the to-be-projected subject selection screen. For this reason, in order to specify the client communication terminal 2 from which a captured image is to be projected, the host has to capture a facial image of a participant whose captured image is to be projected and has to select the participant whose facial image is to be projected, from the captured images of the participants on the to-be-projected subject selection screen.

In order to avoid such a situation, in the video display system according to the present embodiment, the projector 1 is configured such that all what a host has to do is to capture a facial image of a participant whose captured image is to be project to select the client communication terminal 2 from which a captured image is to be projected. Due to this configuration, in the video display system according to the present embodiment, the host no longer has to select a participant whose facial image is to be projected, from the captured images of the participants on the to-be-projected subject selection screen.

Embodiments of the present invention are described below in detail with reference to the drawings. Note that like reference signs are given to elements similar to those described in the first to sixth embodiments, and overlapping descriptions with the description of the first to sixth embodiments are omitted.

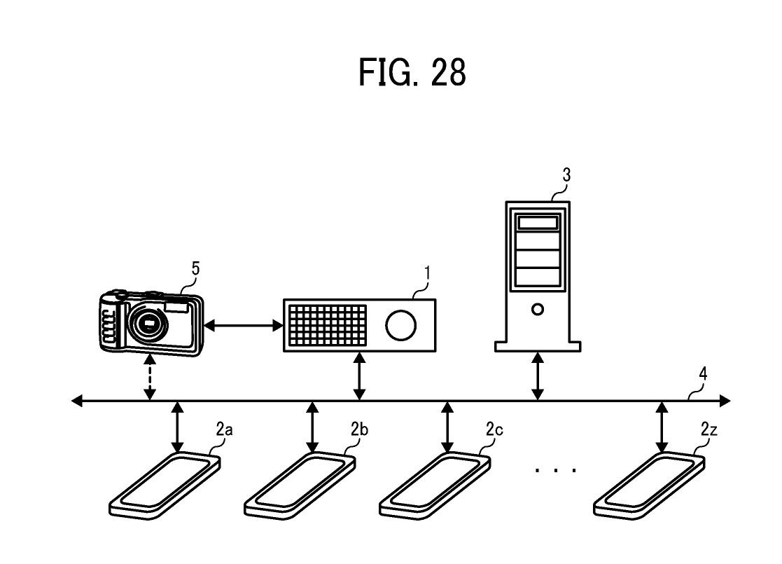

FIG. 28 illustrates a configuration of a video display system according to the present embodiment.

As illustrated in FIG. 28, in the video display system according to the present embodiment, the projector 1, the client communication terminals 2a to 2z, the DHCP server 3, and a camera 5 are connected to each other through the network 4. The camera 5 may be connected to the projector 1 through the communication interface 19. Alternatively, the imaging device 18 that is provided for each of the client communication terminals 2a to 2z may be used as the camera 5.

Note that the camera 5 is configured by hardware that is similar to the hardware as described above with reference to FIG. 2, but the camera 5 does not have to be provided with the projection device 14. Moreover, the HDD 13 may be substituted by a removable and portable storage medium. The camera 5 is disposed at a position where the camera can capture all the people including the host and all the participants.

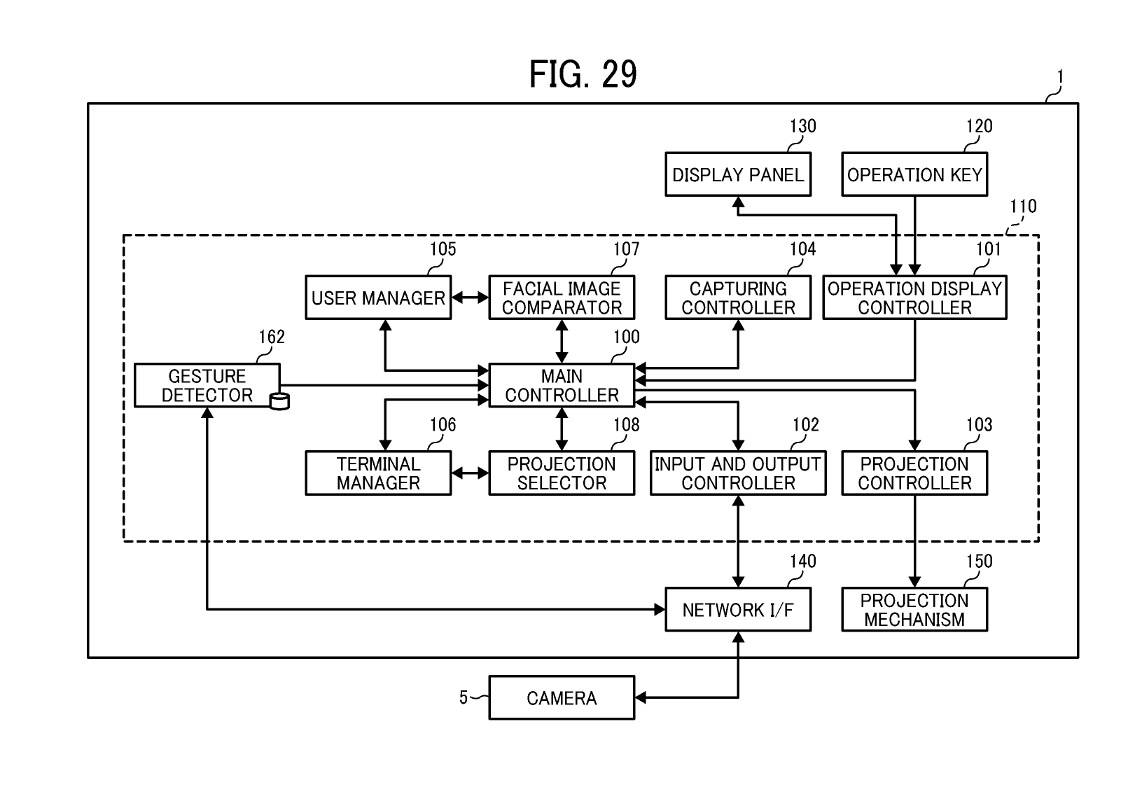

FIG. 29 is a schematic block diagram illustrating a functional configuration of the projector 1 according to the present embodiment.

As illustrated in FIG. 29, the projector 1 according to the present embodiment further includes a gesture detector 162 in addition to the elements described above in the first to sixth embodiments. Note also that the projector 1 according to the present embodiment does not have to include the hot spot detector 109.

The gesture detector 162 obtains the moving images captured by the camera 5 through the network interface 140, and recognize a specific gesture in the obtained moving images to detect a participant who made a specific gesture. This indicates that the gesture detector 162 serves as a motion detector. Moreover, the gesture detector 162 extracts a facial image of a participant from which a specific gesture has been detected. Note also that the gesture detector 162 stores a gesture list that includes characteristic information for detecting a specific gesture.

In the present embodiment, the facial image comparator 107 compares the moving images of the participant who made a specific gesture, which are extracted by the gesture detector 162, with the facial images that are registered to the user list managed by the user manager 105, and selects the user ID that is associated with the best-matching facial image from the user list.

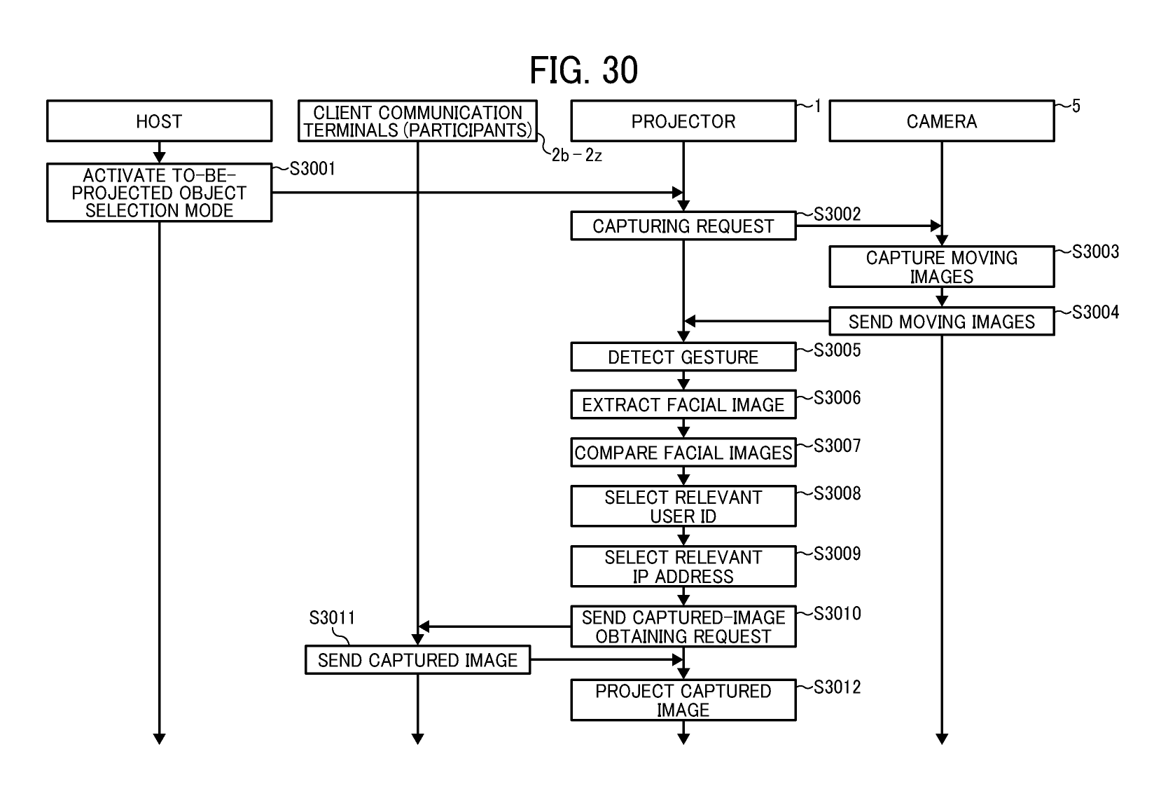

FIG. 30 is a diagram illustrating processes in which the projector 1 according to the present embodiment projects an image captured by the client communication terminal 2.

As illustrated in FIG. 30, when the projector 1 according to the present embodiment projects an image captured by the client communication terminal 2, processes are performed as follows. Firstly, the host operates the client communication terminal 2a to activate a to-be-projected subject selection mode (S3001).

Once the to-be-projected subject selection mode is activated on the client communication terminal 2a, the projector 1 requests the camera 5 to capture images (S3002). The camera 5 capture moving images so as to include all the participants (S3003), and sends the captured moving images to the projector 1 (S3004).

Then, the projector 1 uses the gesture detector 162 to detect a specific gesture from the moving images captured by the camera 5 (S3005), and extracts a facial image of a participant who made a specific gesture (S3006).

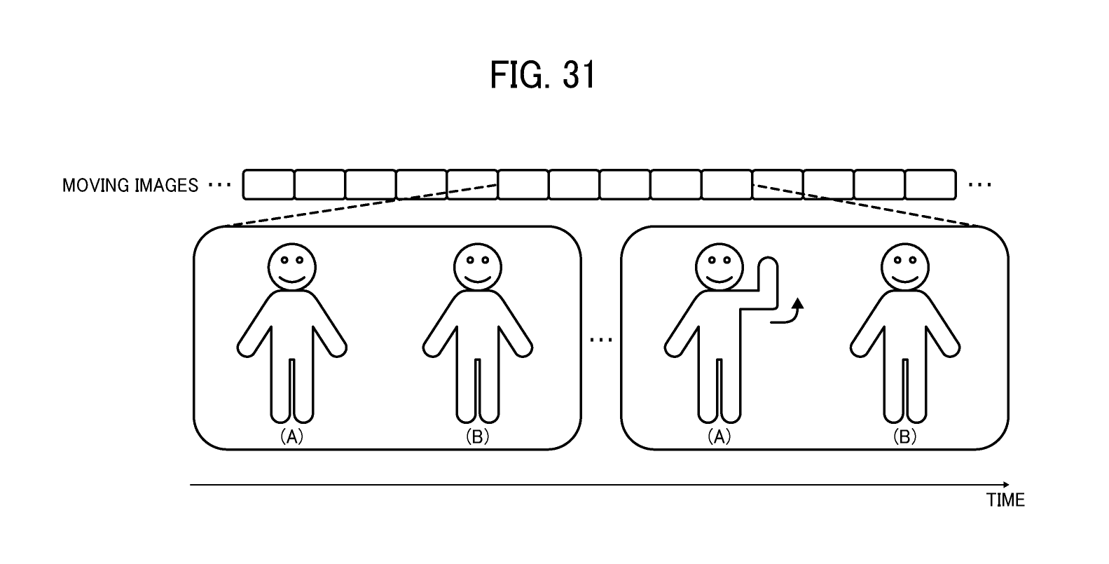

FIG. 31 illustrates two frames of moving images in which the participants (A) and (B) are captured by the camera 5. As illustrated in FIG. 31, the gesture detector 162 detects a specific motion (gesture) from the moving images that are continuously sent from the camera 5, and extracts a facial image of a participant who made a specific gesture.

In FIG. 31, the participant (A) makes an arm-raising gesture, but the participant (B) makes no motion. In such cases, the gesture detector 162 extracts a facial image of the participant (A) who made a gesture, and sends the extracted facial image to the facial image comparator 107.

The projector 1 uses the facial image comparator 107 to compare an extracted facial image with the facial images that are registered to a user list managed by the user manager 105 (S3007), and selects the user ID associated with the facial image that best matches the extracted facial image from the user list managed by the user manager 105 (S3008).

Then, the projector 1 uses the projection selector 108 to select the IP address that is associated with the user ID selected in S3008, from the terminal list managed by the terminal manager 106 (S3009), and sends a captured-image obtaining request to the client communication terminal 2 with the selected IP address (S3010).

Then, the client communication terminal 2 that has received the captured-image obtaining request uses the image capturing unit 204 to capture images and generates a video signal based on the captured images, and sends the generated video signal to the projector 1 (S3011).

Then, after the video signal of the captured images is sent from the client communication terminal 2, the projector 1 projects the captured images of the client communication terminal 2 based on the received video signal of the captured images (S3012).

As described above, in the video display system according to the present embodiment, all what a host has to do is to capture a facial image of a participant whose captured image is to be project to select the client communication terminal 2 from which a captured image is to be projected by the projector 1. Due to this configuration, in the video display system according to the present embodiment, the host no longer has to select a participant whose facial image is to be projected, from the captured images of the participants on the to-be-projected subject selection screen.

### Eighth Embodiment

In the video display system according to the seventh embodiment, right after a participant who made a specific gesture is detected, the projector 1 projects the image captured by the client communication terminal 2 that is associated with the detected participant. However, in the video display system according to the seventh embodiment, the projector 1 is not configured to deal with a situation in which a plurality of participants make a specific gesture.

In order to deal with such a situation, priority levels are given to the participants in the video display system according to the present embodiment. Accordingly, even when there are a plurality of participants who make a specific gesture, the projector 1 according to the present embodiment can project an image captured by the client communication terminal 2 based on the given priority levels.

Embodiments of the present invention are described below in detail with reference to the drawings. Note that like reference signs are given to elements similar to those described in the first to seventh embodiments, and overlapping descriptions with the description of the first to seventh embodiments are omitted.

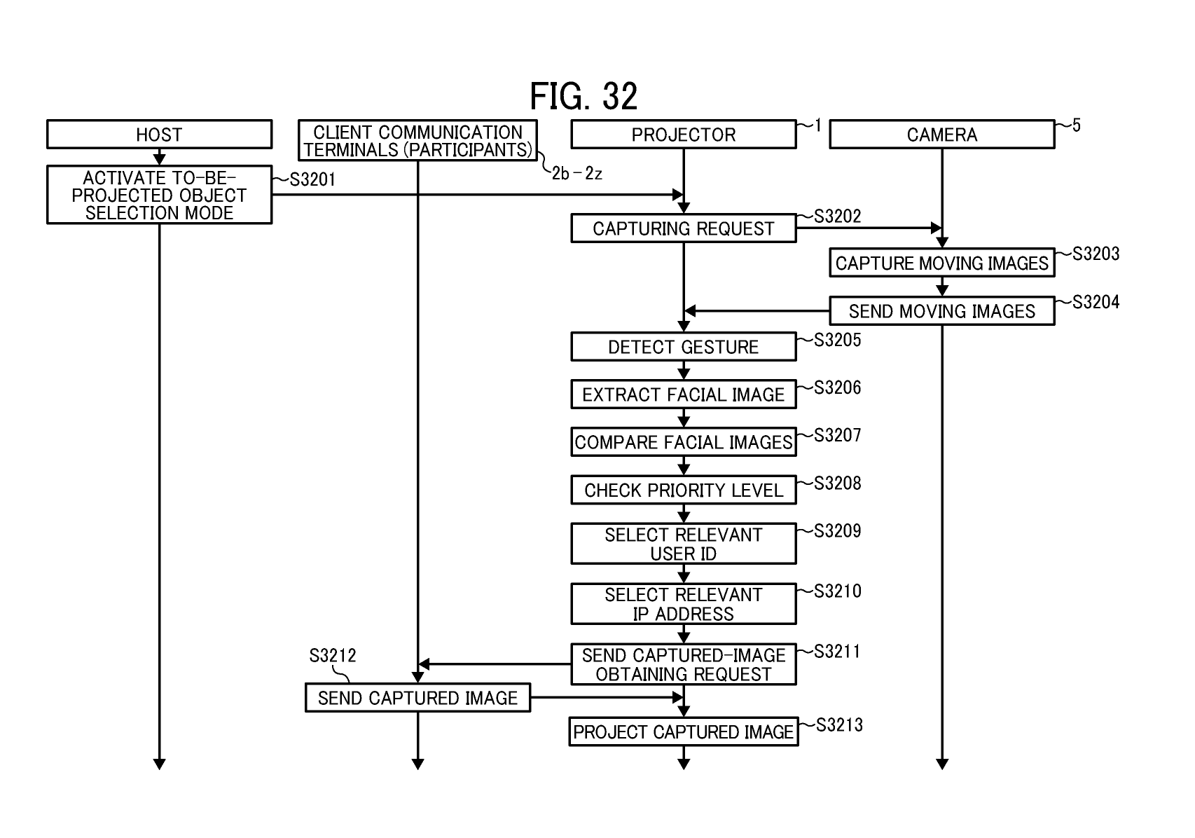

FIG. 32 is a diagram illustrating processes in which the projector 1 according to the present embodiment projects an image captured by the client communication terminal 2.

As illustrated in FIG. 32, when the projector 1 according to the present embodiment projects an image captured by the client communication terminal 2, processes are performed as follows. Firstly, the host operates the client communication terminal 2a to activate a to-be-projected subject selection mode (S3201).

Once the to-be-projected subject selection mode is activated on the client communication terminal 2a, the projector 1 requests the camera 5 to capture images (S3202). The camera 5 capture moving images so as to include all the participants (S3203), and sends the captured moving images to the projector 1 (S3204).

Then, the projector 1 uses the gesture detector 162 to detect a specific gesture from the moving images captured by the camera 5 (S3205), and extracts a facial image of a participant who made a specific gesture (S3206).

The projector 1 uses the facial image comparator 107 to compare an extracted facial image with the facial images that are registered to a user list managed by the user manager 105 (S3207), and

The facial image comparator 107 checks the priority level of a facial image matched in the comparison made in S3207 (S3208). Note that the priority levels are given in advance to the facial images that are registered to the user list.

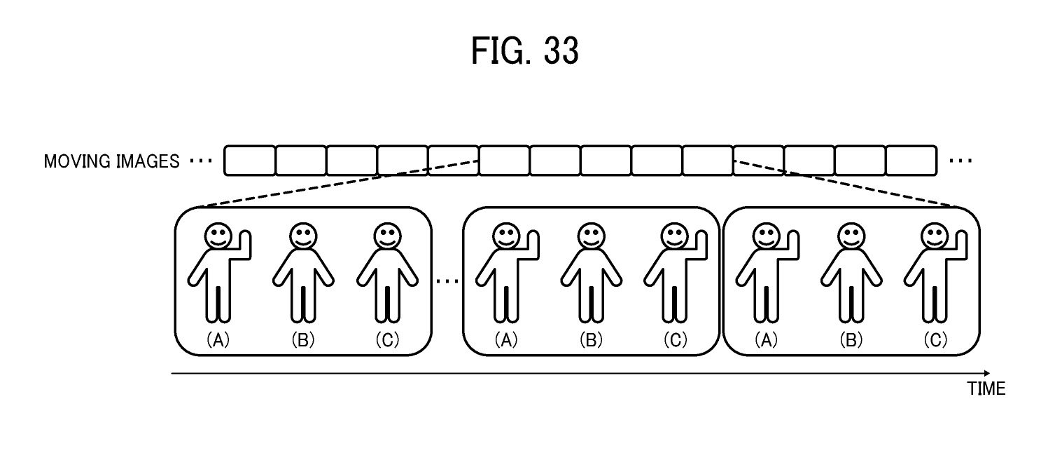

FIG. 33 is a diagram illustrating moving images captured by the camera 5, according to the present embodiment. FIG. 33 illustrates three frames of moving images in which the participants (A), (B), and (C) are captured by the camera 5.

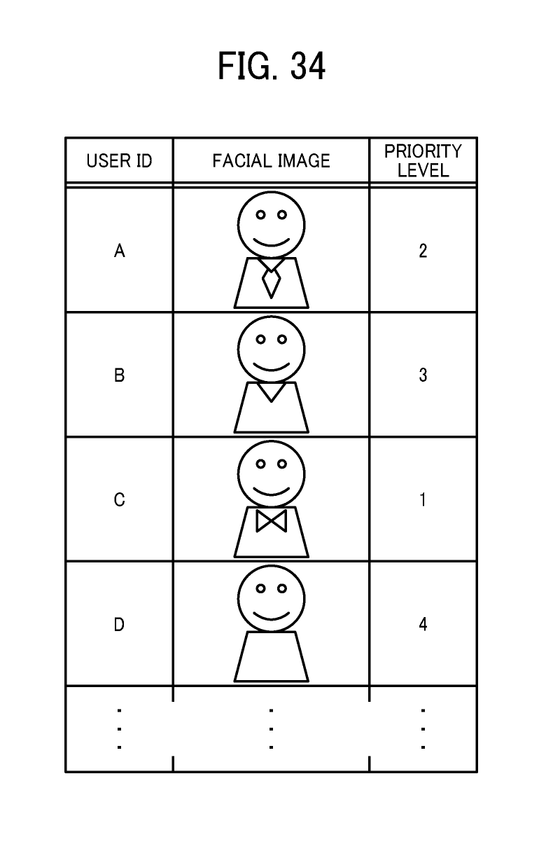

FIG. 34 is a diagram illustrating a user list that the user manager 105 of the projector 1 manages, according to the present embodiment. In FIG. 34, user ID: A, user ID: B, and user ID C are assigned to the participants (A), (B), and (C), respectively.

As illustrated in FIG. 33, the gesture detector 162 detects a specific motion (gesture) from the moving images that are continuously sent from the camera 5, and extracts a facial image of a participant who made a specific gesture.

In FIG. 33, the participant (A) firstly makes an arm-raising gesture, and the participant (C) makes an arm-raising gesture at the second frame. As illustrated in FIG. 34, in the present embodiment, priority levels are given in advance to the facial images of the participants who are registered to the user list.

The projector 1 uses the facial image comparator 107 to select the user ID, which is associated with each of the facial images, from the user list managed by the user manager 105, in the order of the priority levels determined in S3208 (S3209).

Then, the projector 1 uses the projection selector 108 to select the IP address that is associated with the user ID selected in S3209, from the terminal list managed by the terminal manager 106, in order of priority level (S3210), and sends a captured-image obtaining request to the client communication terminal 2 with the selected IP address (S3211).

Accordingly, in FIG. 33, the projection selector 108 selects the participant (C) as a to-be-projected subject prior to the participant (A) who firstly made an arm-raising gesture.

Then, the client communication terminal 2 that has received the captured-image obtaining request uses the image capturing unit 204 to capture images and generates a video signal based on the captured images, and sends the generated video signal to the projector 1 (S3212).

Then, after the video signal of the captured images is sent from the client communication terminal 2, the projector 1 projects the captured images of the client communication terminal 2 based on the received video signal of the captured images (S3213).

As described above, in the video display system according to the present embodiment, even when there are a plurality of participants who make a specific gesture, an image captured by the client communication terminal 2 can be projected based on the priority levels given to the participants. Due to this configuration, in the video display system according to the present embodiment, even when a plurality of participants make a specific gesture, a captured image can be displayed based on the priority levels given to the participants.

### Ninth Embodiment

Then, in the video display system according to the seventh and eighth embodiments, the projector 1 projects the image that is captured by the client communication terminal 2 associated with the participant from which a specific gesture has been detected. However, in the video display system according to the seventh and eighth embodiments, the projector 1 cannot deal with a situation in which a participant make a gesture that is specified as desired by a host.

In order to deal with such a situation, in the video display system according to the present embodiment, the projector 1 registers to the gesture detector 162 a gesture that is specified as desired by a host. Accordingly, the projector 1 can project an image captured by the client communication terminal 2 of the participant who made such a gesture specified by the host.

Embodiments of the present invention are described below in detail with reference to the drawings. Note that like reference signs are given to elements similar to those described in the first to eighth embodiments, and overlapping descriptions with the description of the first to eighth embodiments are omitted.

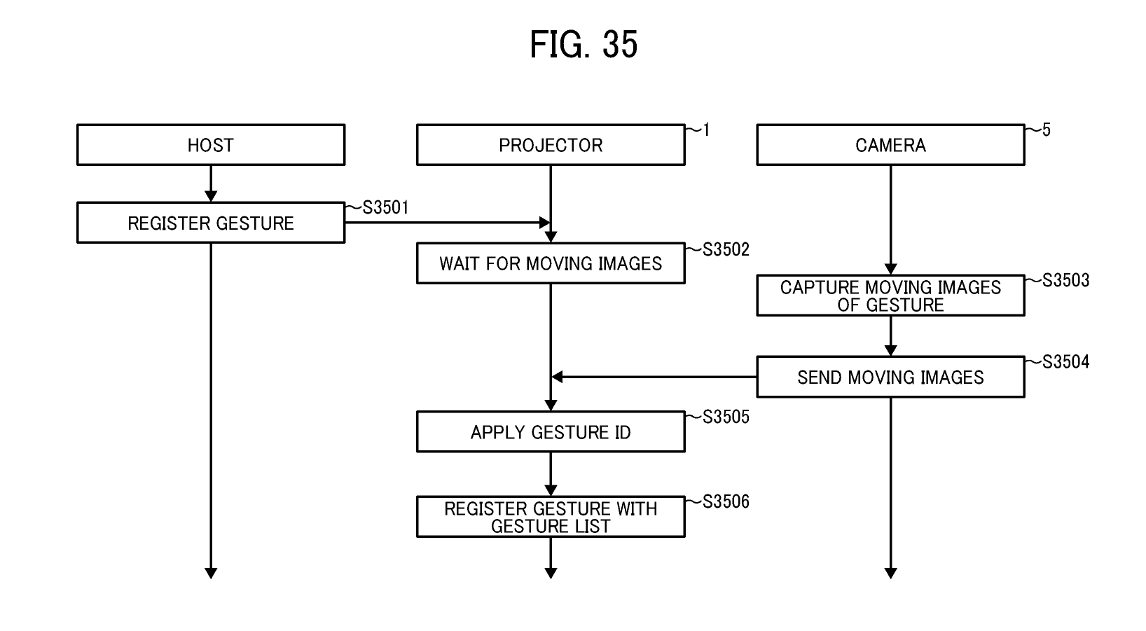

Firstly, processes in which the projector 1 according to the present embodiment registers a gesture to be detected by the gesture detector 162 are described with reference to FIG. 35.

FIG. 35 is a diagram illustrating processes of registering a gesture to be detected, according to the present embodiment.

As illustrated in FIG. 35, when the projector 1 according to the present embodiment registers a gesture to be detected, processes are performed as follows. Firstly, the host operates the client communication terminal 2a to register a gesture (S3501).

Once the client communication terminal 2a is operated to register a gesture, the projector 1 waits until the moving images obtained by capturing the registered gesture are sent from the camera 5 (S3502). The host makes any desired gesture, and uses the camera 5 to capture the moving images of such a gesture (S3503).

The camera 5 sends the captured moving images of the gesture to the projector 1 (S3504), and the projector 1 uses the gesture detector 162 to extract characteristics of the received moving images of the gesture. Then, the gesture detector 162 applies gesture ID to the characteristic information of the moving images of the gesture (S3505), and registers the gesture with the gesture list stored in the gesture detector 162 (S3506).

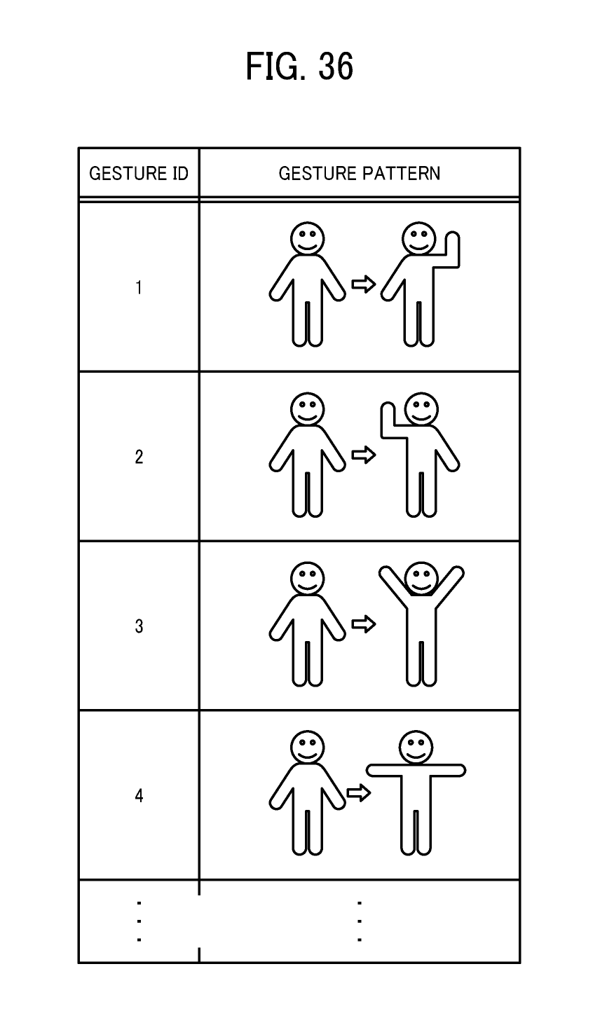

FIG. 36 is a diagram illustrating a gesture list according to the present embodiment. As illustrated in FIG. 36, in the gesture list according to the present embodiment, each gesture pattern is associated with gesture ID. Note that the gesture pattern is characteristic information in the moving images of a gesture. In the present embodiment, the gesture detector 162 detects a gesture made by a participant based on the gesture list as illustrated in FIG. 36. By repeating the processes in FIG. 35, a plurality of kinds of gesture patterns can be stored in the gesture list.

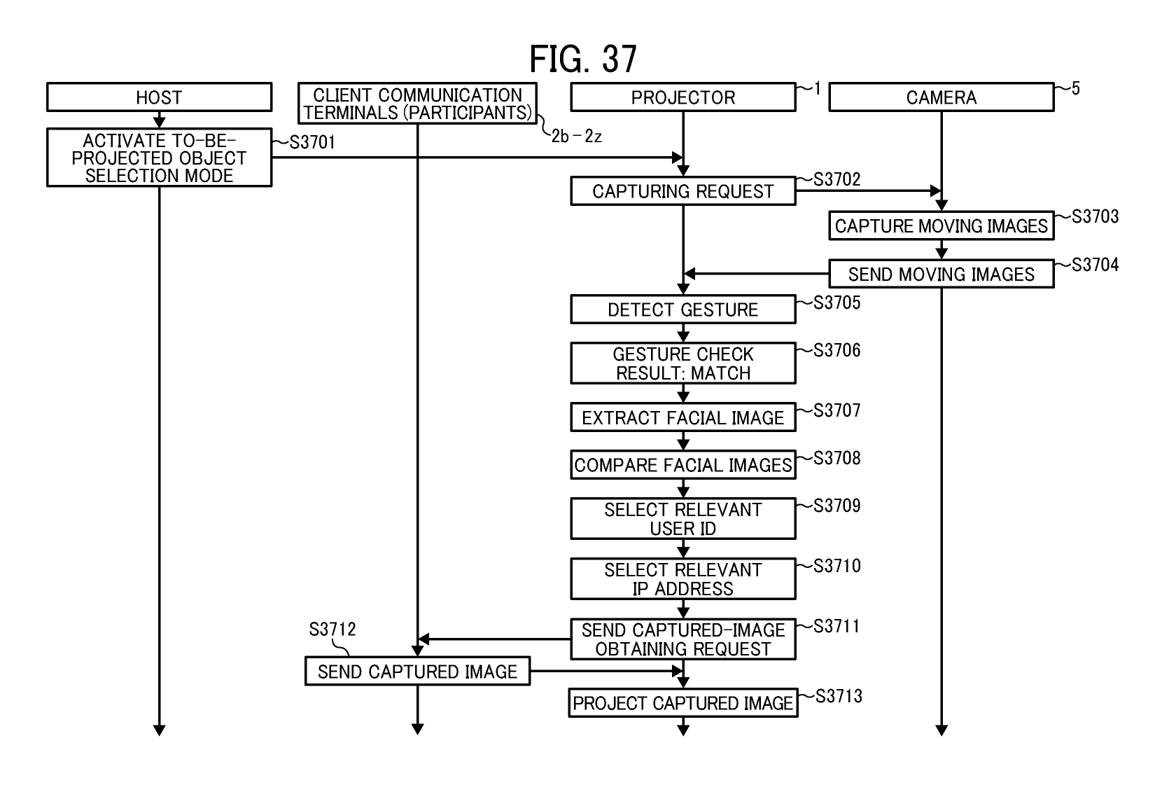

FIG. 37 is a diagram illustrating processes in which the projector 1 according to the present embodiment projects an image captured by the client communication terminal 2.

As illustrated in FIG. 37, when the projector 1 according to the present embodiment projects an image captured by the client communication terminal 2, processes are performed as follows. Firstly, the host operates the client communication terminal 2a to activate a to-be-projected subject selection mode (S3701).

Once the to-be-projected subject selection mode is activated on the client communication terminal 2a, the projector 1 requests the camera 5 to capture images (S3702). The camera 5 capture moving images so as to include all the participants (S3703), and sends the captured moving images to the projector 1 (S3704).

Then, the projector 1 uses the gesture detector 162 to detect a specific gesture from the moving images captured by the camera 5 (S3705), and checks whether the detected gesture is registered to the gesture list (S3706). The gesture detector 162 confirms that one of the gestures registered to the gesture list matches the detected gesture, and extracts a facial image of the participant who made that gesture (S3707).

The projector 1 uses the facial image comparator 107 to compare an extracted facial image with the facial images that are registered to a user list managed by the user manager 105 (S3708), and selects the user ID associated with the facial image that best matches the extracted facial image from the user list managed by the user manager 105 (S3709).

Then, the projector 1 uses the projection selector 108 to select the IP address that is associated with the user ID selected in S3709, from the terminal list managed by the terminal manager 106 (S3710), and sends a captured-image obtaining request to the client communication terminal 2 with the selected IP address (S3711).

Then, the client communication terminal 2 that has received the captured-image obtaining request uses the image capturing unit 204 to capture images and generates a video signal based on the captured images, and sends the generated video signal to the projector 1 (S3712).

Then, after the video signal of the captured images is sent from the client communication terminal 2, the projector 1 projects the captured images of the client communication terminal 2 based on the received video signal of the captured images (S3713).

As described above, the video display system according to the present embodiment is configured such that an image captured by the client communication terminal 2 is projected according to the priority level that is given to a participant who made a gesture specified as desired by a host. Due to this configuration, in the video display system according to the present embodiment, an image that is captured by the client communication terminal 2 of the participant who made a gesture specified as desired by the host can be displayed.

### Tenth Embodiment

Then, in the video display system according to the seventh to ninth embodiments, the projector 1 projects the image that is captured by the client communication terminal 2 associated with the participant from which a specific gesture has been detected. However, in the video display system according to the seventh to ninth embodiments, the projector 1 can merely project the image captured by the client communication terminal 2 from which a captured image is to be projected.

In order to deal with such a situation, in the video display system according to the present embodiment, the projector 1 registers for every gesture a set of data for controlling the projection of the client communication terminal 2. Accordingly, the projection of an image captured by the client communication terminal 2 can be controlled just by a gesture of a participant.

Embodiments of the present invention are described below in detail with reference to the drawings. Note that like reference signs are given to elements similar to those described in the first to ninth embodiments, and overlapping descriptions with the description of the first to ninth embodiments are omitted.

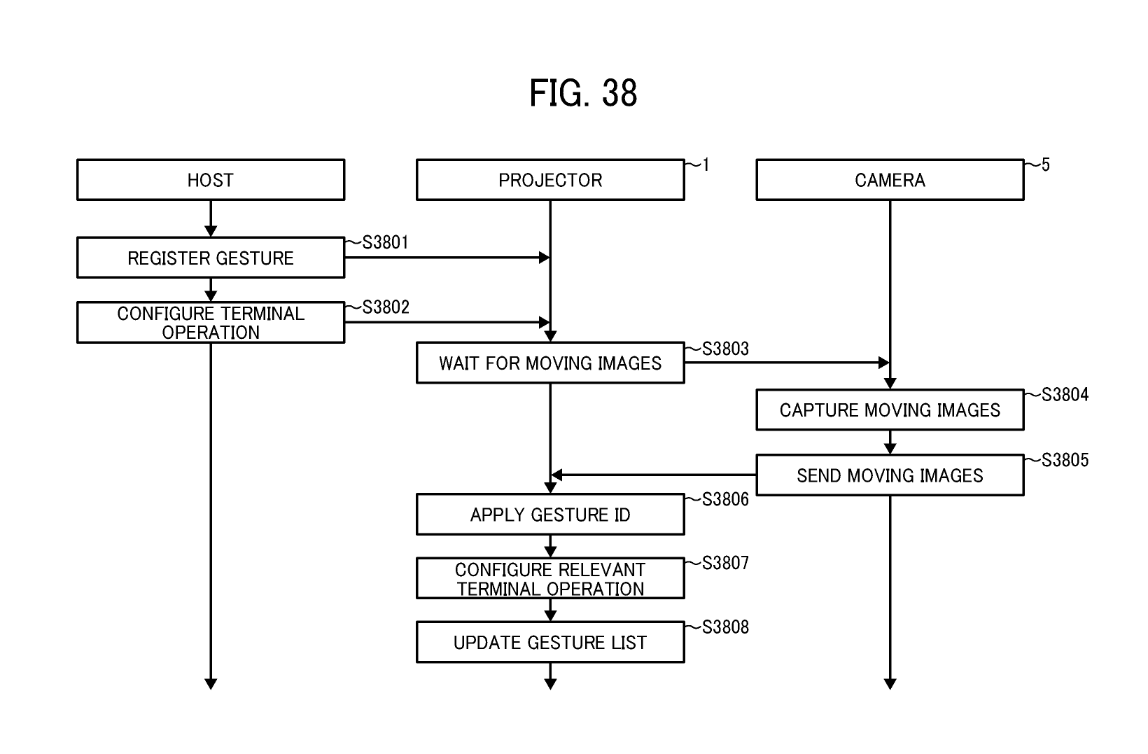

Firstly, processes in which the projector 1 according to the present embodiment registers a gesture to be detected by the gesture detector 162 and a set of data for controlling the projection of the client communication terminal 2 in association with each other are described with reference to FIG. 38.

FIG. 38 is a diagram illustrating processes of registering a gesture to be detected, according to the present embodiment.

As illustrated in FIG. 38, when the projector 1 according to the present embodiment registers a gesture to be detected and a set of data for controlling the projection of the client communication terminal 2, processes are performed as follows. Firstly, the host operates the client communication terminal 2a to register a gesture (S3801) and to configure terminal operation (S3802).

Once the client communication terminal 2a is operated to register a gesture and configure terminal operation, the projector 1 waits until the moving images obtained by capturing the registered gesture are sent from the camera 5 (S3803). The host makes any desired gesture, and uses the camera 5 to capture the moving images of such a gesture (S3804).

The camera 5 sends the captured moving images of the gesture to the projector 1 (S3805), and the projector 1 uses the gesture detector 162 to extract characteristics of the received moving images of the gesture. Then, the gesture detector 162 applies gesture ID to the characteristic information of the moving images of the gesture (S3806), and registers the set of data for controlling the projection of the client communication terminal 2 (S3807). Note also that the set of data for controlling the projection of the client communication terminal 2 is set when the terminal operation is configured in S3802.

Then, the gesture detector 162 registers the information with the gesture list stored in the gesture detector 162 (S3808). This indicates that the gesture detector 162 serves as a relevant terminal operation information storage unit.

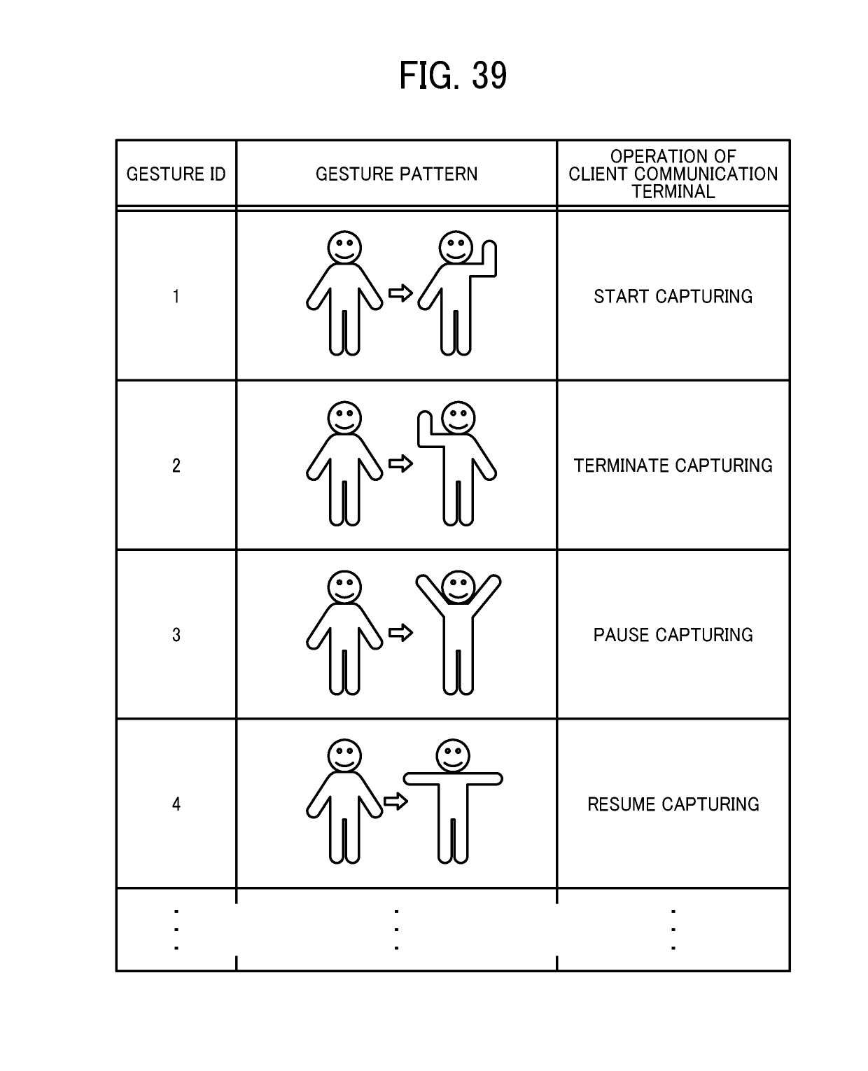

FIG. 39 is a diagram illustrating a gesture list according to the present embodiment. As illustrated in FIG. 39, in the gesture list according to the present embodiment, the gesture patterns, the gesture ID, and the set of data for controlling the projection of the client communication terminal 2 are associated with each other. Note also that the gesture patterns, the gesture ID, and the set of data for controlling the projection of the client communication terminal 2 may collectively be referred to as relevant terminal operation information in the following description.

In the present embodiment, the gesture detector 162 of the projector 1 detects a gesture made by a participant based on the gesture list as illustrated in FIG. 39, and controls the projection of the client communication terminal 2 based on the data that is associated with the detected gesture.

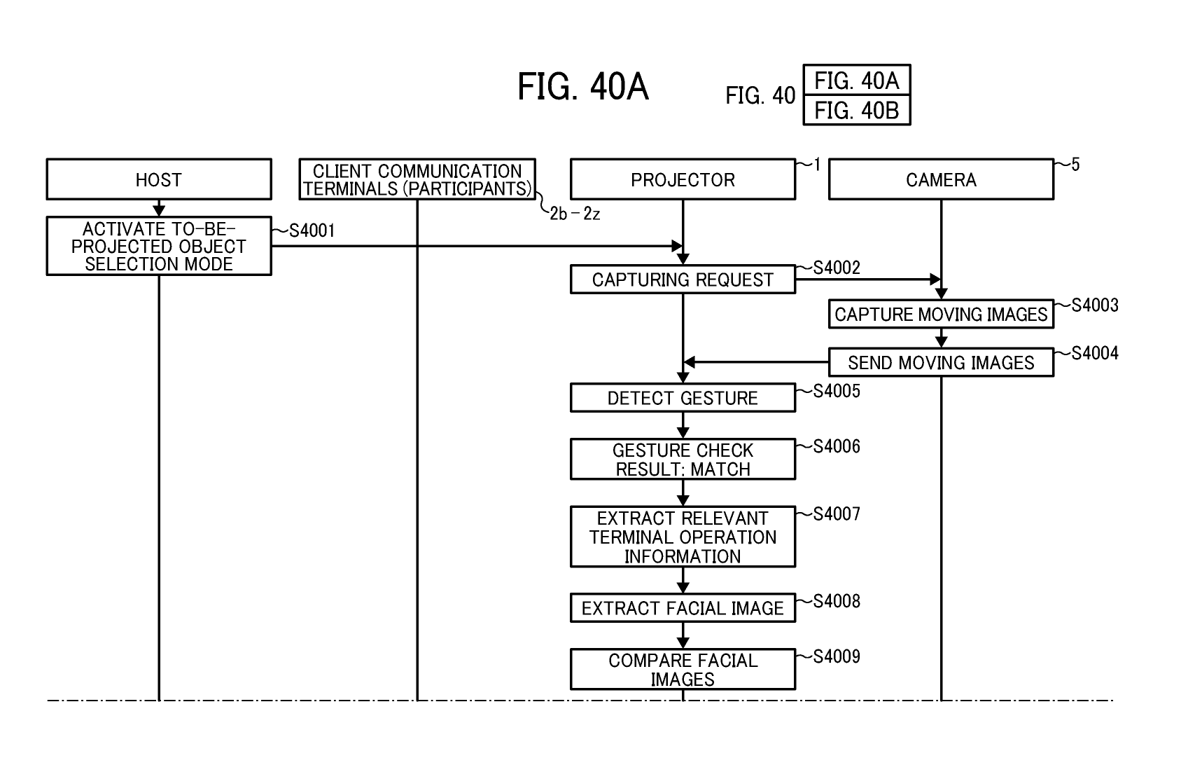

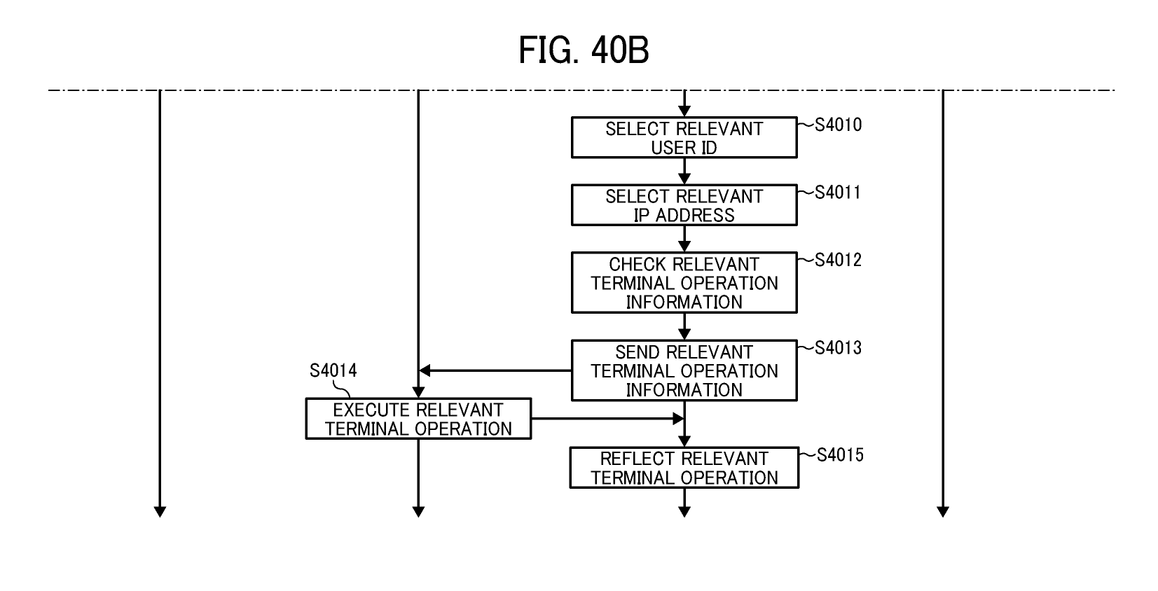

FIG. 40A and FIG. 40B are a diagram illustrating processes in which the projector 1 according to the present embodiment projects an image captured by the client communication terminal 2.

As illustrated in FIG. 40A and FIG. 40B, when the projector 1 according to the present embodiment projects an image captured by the client communication terminal 2, processes are performed as follows. Firstly, the host operates the client communication terminal 2a to activate a to-be-projected subject selection mode (S4001).

Once the to-be-projected subject selection mode is activated on the client communication terminal 2a, the projector 1 requests the camera 5 to capture images (S4002). The camera 5 capture moving images so as to include all the participants (S4003), and sends the captured moving images to the projector 1 (S4004).

Then, the projector 1 uses the gesture detector 162 to detect a specific gesture from the moving images captured by the camera 5 (S4005), and checks whether the detected gesture is registered to the gesture list (S4006). The gesture detector 162 confirms that one of the gestures registered to the gesture list matches the detected gesture, and extracts relevant terminal operation information from the gesture list (S4007).

Then, the gesture detector 162 extracts a facial image of a participant who made a specific gesture, from the moving images captured by the camera 5 (S4008).

The projector 1 uses the facial image comparator 107 to compare an extracted facial image with the facial images that are registered to a user list managed by the user manager 105 (S4009), and selects the user ID associated with the facial image that best matches the extracted facial image from the user list managed by the user manager 105 (S4010).

Then, the projector 1 uses the projection selector 108 to select the IP address that is associated with the user ID selected in S4010, from the terminal list managed by the terminal manager 106 (S4011), and checks the relevant terminal operation information (S4012). sends the relevant terminal operation information to the client communication terminal 2 with the selected IP address (S4013).

Then, the client communication terminal 2 that have received the relevant terminal operation information executes the relevant terminal operation in the gesture list (S4014). The projector 1 uses the image capturing unit 204 to reflects the relevant terminal operation on the client communication terminal 2 in the capturing status (S4015).

Accordingly, for example, when a gesture with the gesture ID: 1 is detected by the gesture detector 162, the projection of an image captured by the client communication terminal 2 on the projector 1 starts. When a gesture with the gesture ID: 2 is detected by the gesture detector 162, the projection of the image captured by the client communication terminal 2 on the projector 1 is terminated.

When a gesture with the gesture ID: 3 is detected by the gesture detector 162, the projection of the image captured by the client communication terminal 2 on the projector 1 is temporarily paused. When a gesture with the gesture ID: 4 is detected by the gesture detector 162, the projection of the image captured by the client communication terminal 2 on the projector 1 is resumed.

As described above, in the video display system according to the present embodiment, the projector 1 registers for every gesture a set of data for controlling the projection of the client communication terminal 2. Accordingly, the projection of an image captured by the client communication terminal 2 can be controlled just by a gesture of a participant.

### Eleventh Embodiment

Then, in the video display system according to the seventh to tenth embodiments, the projector 1 projects the image that is captured by the client communication terminal 2 associated with the participant from which a specific gesture has been detected. However, in the video display system according to the seventh to tenth embodiments, the participant who is associated with the client communication terminal 2 from which a captured image is to be projected cannot terminate the projection of the captured image at a desired timing.

In order to deal with such a situation, in the video display system according to the present embodiment, the projector 1 only allows the participant who is associated with the client communication terminal 2 from which a captured image is to be projected to control the projection of the image captured by the client communication terminal 2. Accordingly, the projection of an image captured by the client communication terminal 2 can be controlled at a timing desired by a participant.

Embodiments of the present invention are described below in detail with reference to the drawings. Note that like reference signs are given to elements similar to those described in the first to tenth embodiments, and overlapping descriptions with the description of the first to tenth embodiments are omitted.

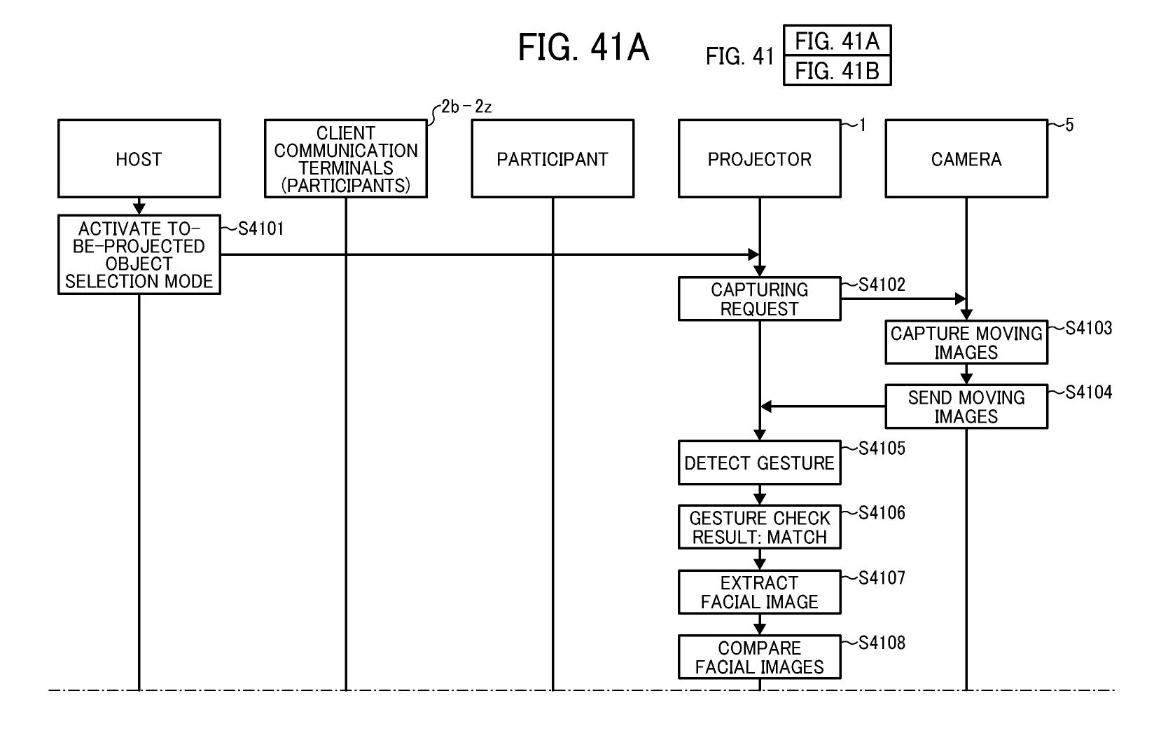

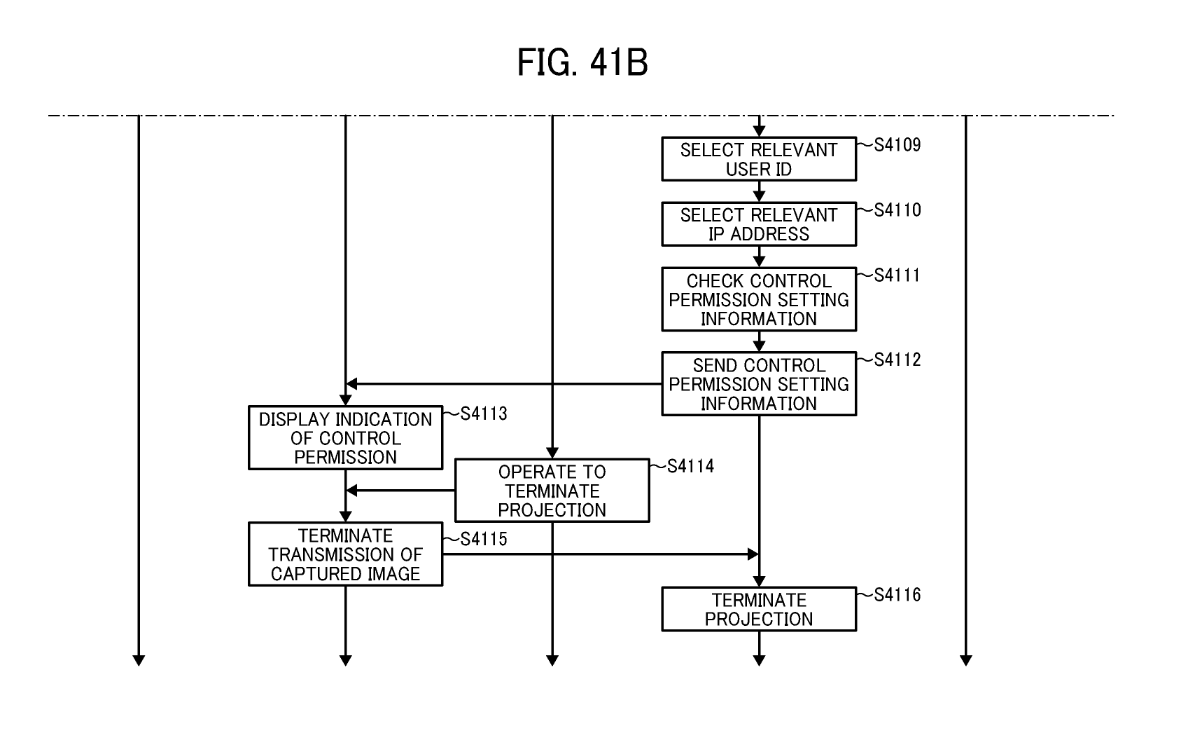

FIG. 41A and FIG. 41B are a diagram illustrating processes in which the projector 1 according to the present embodiment terminates the projection of an image captured by the client communication terminal 2.

As illustrated in FIG. 41A and FIG. 41B, when the projector 1 according to the present embodiment terminates the projection of an image captured by the client communication terminal 2, processes are performed as follows. Firstly, the host operates the client communication terminal 2a to activate a to-be-projected subject selection mode (S4101).

Once the to-be-projected subject selection mode is activated on the client communication terminal 2a, the projector 1 requests the camera 5 to capture images (S4102). The camera 5 capture moving images so as to include all the participants (S4103), and sends the captured moving images to the projector 1 (S4104).

Then, the projector 1 uses the gesture detector 162 to detect a specific gesture from the moving images captured by the camera 5 (S4105), and checks whether the detected gesture is registered to the gesture list (S4106). The gesture detector 162 confirms that one of the gestures registered to the gesture list matches the detected gesture, and extracts a facial image of a participant who made a specific gesture, from the moving images captured by the camera 5 (S4107).

The projector 1 uses the facial image comparator 107 to compare an extracted facial image with the facial images that are registered to a user list managed by the user manager 105 (S4108), and selects the user ID associated with the facial image that best matches the extracted facial image from the user list managed by the user manager 105 (S4109).

Then, the projector 1 uses the projection selector 108 to select the IP address that is associated with the user ID selected in S4109, from the terminal list managed by the terminal manager 106 (S4110), and checks control permission setting information (S4111).

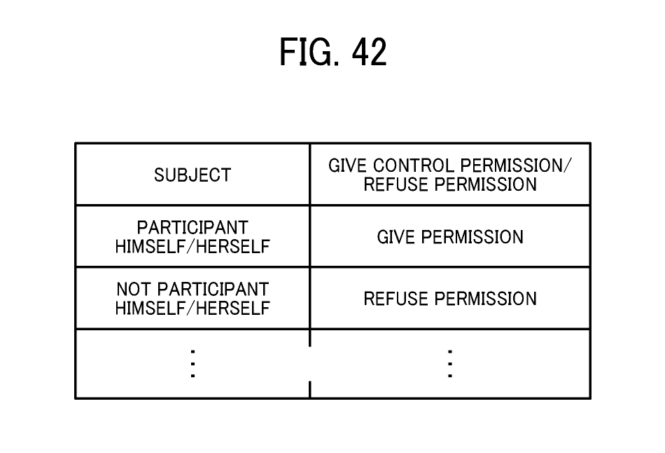

FIG. 42 is a diagram illustrating control permission setting information associated with the client communication terminal 2, according to the present embodiment. As illustrated in FIG. 42, in the control permission setting information, whether or not a participant is to be allowed to control the projection from the client communication terminal 2 is determined depending on whether the participant who is selected by the projection selector 108 to be the to-be-projected subject is the participant himself or herself who is associated with the client communication terminal 2. Note also that the control permission setting information is stored in the terminal manager 106 in the present embodiment.

Hereinafter, the participant who is selected by the projection selector 108 to be the to-be-projected subject is assumed to be the participant himself or herself who is associated with the client communication terminal 2. The projector 1 uses the main controller 100 to send the control permission setting information to the client communication terminal 2 that is selected as a to-be-projected subject by the projection selector 108 (S4112).

Once the control permission setting information is received, the client communication terminal 2 uses the operation display controller 201 to display an indication of control permission on the display panel 230 (S4113). Note that the indication of control permission allows the participant to control the projection of an image captured by the client communication terminal 2.

When the participant operates the client communication terminal 2 of his/her own to terminate the projection while the indication of control permission is being displayed (S4114), the client communication terminal 2 terminates the transmission of a captured image (S4115), and the projector 1 stops projecting the image captured by the client communication terminal 2 (S4116).

As described above, in the video display system according to the present embodiment, the projector 1 only allows the participant who is associated with the client communication terminal 2 from which a captured image is to be projected to control the projection of the image captured by the client communication terminal 2. Accordingly, the projection of an image captured by the client communication terminal 2 can be controlled at a timing desired by a participant.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Further, as described above, any one of the above-described and other methods of the present invention may be embodied in the form of a computer program stored on any kind of storage medium. Examples of storage media include, but are not limited to, flexible disks, hard disks, optical discs, magneto-optical discs, magnetic tape, nonvolatile memory cards, ROM, etc. Alternatively, any one of the above-described and other methods of the present invention may be implemented by ASICs, prepared by interconnecting an appropriate network of conventional component circuits, or by a combination thereof with one or more conventional general-purpose microprocessors and/or signal processors programmed accordingly.

What is claimed is:

1. A video display system comprising:
a plurality of information processing devices;
a facial image acquisition unit to obtain a facial image of a user who uses at least one of the plurality of information processing devices;
a facial image comparator to compare the obtained facial image with a plurality of facial images each of which is associated with each of the plurality of information processing devices, the plurality of facial images being stored in advance as association information;
an information processing device selector to select one of the plurality of information processing devices associated with the obtained facial image, based on a result of comparison between the obtained facial image and the plurality of facial images;
a video signal acquisition unit to receive a video signal from the selected one of the plurality of information processing devices; and
a video display device to display a video based on the obtained video signal.

2. The video display system according to claim 1, wherein
the facial image comparator compares the obtained facial image with the plurality of facial images each of which is associated with one of plurality of pieces of identification information identifying each of the plurality of information processing devices,
the information processing device selector selects one of the plurality of pieces of identification information associated with the plurality of facial images in the association information, based on a result of comparison between the obtained facial image and the plurality of facial images, and
the video signal acquisition unit receives the video signal from one of the plurality of information processing devices identified by the selected one of the plurality of piece of identification information.

3. The video display system according to claim 1, further comprising:
an association information registration unit to register the plurality of facial images to the association information in association with a plurality of pieces of individual identification information that identify the plurality of information processing devices individually; and
an associating unit to associate location identification information for identifying location of each of the plurality of information processing devices on a network with each of the plurality of pieces of individual identification information, for each of the plurality of information processing devices,
wherein
the facial image comparator compares the obtained facial image with the plurality of images registered to the association information,
the information processing device selector selects one of the plurality of pieces of individual identification information, based on a result of comparison between the obtained facial image and the plurality of facial images, and
the video signal acquisition unit receives the video signal from one of the plurality of information processing devices whose location is identified by the location identification information that is associated with the selected one of the plurality of pieces of individual identification information.

4. The video display system according to claim 1, further comprising:
an association information registration unit to register the plurality of facial images to the association information in association with a plurality of pieces of individual identification information that identify the plurality of information processing devices individually;
a location identification information acquisition unit to obtain location identification information for identifying location of each of the plurality of information processing devices on a network, from each of the plurality of information processing devices; and
an associating unit to associate the obtained location identification information with each of the plurality of pieces of individual identification information, for each of the plurality of information processing devices,
wherein
the facial image comparator compares the obtained facial image with the plurality of images registered to the association information,
the information processing device selector selects one of the plurality of pieces of individual identification information, based on a result of comparison between the obtained facial image and the plurality of facial images, and
the video signal acquisition unit receives the video signal from one of the plurality of information processing devices whose location is identified by the location identification information that is associated with the selected one of the plurality of pieces of individual identification information.

5. The video display system according to claim 1, further comprising:
an association information registration unit to register the plurality of facial images to the association information in association with a plurality of pieces of individual identification information that identify the plurality of information processing devices individually;
a location identification information acquisition unit to obtain location identification information for identifying location of each of the plurality of information processing devices on a network, from a location identification information manager that manages the location identification information of the plurality of information processing devices; and
an associating unit to associate the obtained location identification information with each of the plurality of pieces of individual identification information, for each of the plurality of information processing devices,
wherein
the facial image comparator compares the obtained facial image with the plurality of images registered to the association information,
the information processing device selector selects one of the plurality of pieces of individual identification information, based on a result of comparison between the obtained facial image and the plurality of facial images, and
the video signal acquisition unit receives the video signal from one of the plurality of information processing devices whose location is identified by the location identification information that is associated with the selected one of the plurality of pieces of individual identification information.

6. The video display system according to claim 1, further comprising
a capturing unit to capture a surrounding image,
wherein the facial image acquisition unit obtains a facial image of a person captured by the capturing unit.

7. The video display system according to claim 6, wherein
at least one of the video display device and the information processing devices includes the capturing unit.

8. The video display system according to claim 1, further comprising
a source determination unit to determine whether or not each of the plurality of information processing devices is a source of the obtained video signal.

9. The video display system according to claim 1, further comprising:
a capturing unit to capture a video around the capturing unit; and
a motion detector to recognize a specific motion in the video obtained by the capturing unit and detect a person who made the specific motion,
wherein the facial image acquisition unit obtains a facial image of the detected person.

10. The video display system according to claim 9, wherein
the motion detector gives a priority to the person who made the specific motion,
the facial image acquisition unit obtains a facial image of the detected person based on the given priority,
the facial image comparator compares the facial image obtained based on the priority with the plurality of facial images associated with plurality of information processing devices, and
the information processing device selector selects one of the plurality of information processing devices associated with the plurality of facial images in the association information, based on a result of comparison between the obtained facial image and the plurality of facial images.

11. The video display system according to claim 9, wherein
the motion detector recognizes specific and multiple kinds of motions in the video and detects a person who made the motions.

12. The video display system according to claim 11, further comprising
a relevant terminal operation information storage unit to store characteristic information of the specific and multiple kinds of motions in association with relevant terminal operation information for controlling the information processing devices.

13. The video display system according to claim 12, further comprising
a video display controller to control the video displayed on the video display device,
the motion detector recognizes the motions performed by a person associated with the information processing device selected as a source of the video signal,
wherein the video display controller controls the video displayed on the video display device based on the relevant terminal operation information.

14. The video display system according to claim 12, further comprising
a video display controller to control the video displayed on the video display device,
wherein
the motion detector recognizes the motions performed by a person other than a person associated with the information processing device selected as a source of the video signal,
the video display controller controls the video displayed on the video display device based on the relevant terminal operation information.

15. A method of controlling display of an image, the method comprising:
obtaining a facial image of a user who uses at least one of a plurality of information processing devices;
comparing the obtained facial image with a plurality of facial images each of which is associated with each of the plurality of information processing devices, the plurality of facial images being stored in advance as association information;
selecting one of the plurality of information processing devices associated with the obtained facial image, based on a result of comparison between the obtained facial image and the plurality of facial images;
receiving a video signal from the selected one of the plurality of information processing devices; and
displaying a video based on the received video signal.

16. The method according to claim 15, wherein
the comparing further includes comparing the obtained facial image with the plurality of facial images each of which is associated with one of plurality of pieces of identification information identifying each of the plurality of information processing devices,
the selecting further includes selecting one of the plurality of pieces of identification information associated with the plurality of facial images in the association information, based on a result of comparison between the obtained facial image and the plurality of facial images, and
the receiving the video signal further includes receiving the video signal from one of the plurality of information processing devices identified by the selected one of the plurality of piece of identification information.

17. The method according to claim 15, further comprising:
registering the plurality of facial images to the association information in association with a plurality of pieces of individual identification information that identify the plurality of information processing devices individually; and
associating location identification information for identifying location of each of the plurality of information processing devices on a network with each of the plurality of pieces of individual identification information, for each of the plurality of information processing devices,
wherein
the comparing further includes comparing the obtained facial image with the plurality of images registered to the association information,
the selecting further includes selecting one of the plurality of pieces of individual identification information, based on a result of comparison between the obtained facial image and the plurality of facial images, and
the receiving the video signal further includes receiving the video signal from one of the plurality of information processing devices whose location is identified by the location identification information that is associated with the selected one of the plurality of pieces of individual identification information.

18. The method according to claim 15, further comprising:
registering the plurality of facial images to the association information in association with a plurality of pieces of individual identification information that identify the plurality of information processing devices individually;
obtaining location identification information for identifying location of each of the plurality of information processing devices on a network, from each of the plurality of information processing devices; and
associating the obtained location identification information with each of the plurality of pieces of individual identification information, for each of the plurality of information processing devices,
wherein
the comparing further includes comparing the obtained facial image with the plurality of images registered to the association information,
the selecting further includes selecting one of the plurality of pieces of individual identification information, based on a result of comparison between the obtained facial image and the plurality of facial images, and
the receiving the video signal further includes receiving the video signal from one of the plurality of information processing devices whose location is identified by the location identification information that is associated with the selected one of the plurality of pieces of individual identification information.

19. The method according to claim 15, further comprising:
registering the plurality of facial images to the association information in association with a plurality of pieces of individual identification information that identify the plurality of information processing devices individually;
obtaining location identification information for identifying location of each of the plurality of information processing devices on a network, from a location identification information manager that manages the location identification information of the plurality of information processing devices; and
associating the obtained location identification information with each of the plurality of pieces of individual identification information, for each of the plurality of information processing devices,
wherein
the comparing further includes comparing the obtained facial image with the plurality of images registered to the association information,
the selecting further includes selecting one of the plurality of pieces of individual identification information, based on a result of comparison between the obtained facial image and the plurality of facial images, and
the receiving the video signal further includes receiving the video signal from one of the plurality of information processing devices whose location is identified by the location identification information that is associated with the selected one of the plurality of pieces of individual identification information.

20. A computer-readable non-transitory recording medium storing a program for causing a computer to execute a method of controlling display of an image, the method comprising:
obtaining a facial image of a user who uses at least one of a plurality of information processing devices;
comparing the obtained facial image with a plurality of facial images each of which is associated with each of the plurality of information processing devices, the plurality of facial images being stored in advance as association information;
selecting one of the plurality of information processing devices associated with the obtained facial image, based on a result of comparison between the obtained facial image and the plurality of facial images;
receiving a video signal from the selected one of the plurality of information processing devices; and
displaying a video based on the obtained video signal.
